(19) United States
(12) Patent Application Publication
(10) Pub. No.: US 2016/0229188 A1
(43) Pub. Date: Aug. 11, 2016

(54) LIQUID DISCHARGE APPARATUS AND CONTROL METHOD OF LIQUID DISCHARGE APPARATUS

(71) Applicant: SEIKO EPSON CORPORATION, Tokyo (JP)

(72) Inventors: Tomoyoshi KAKEGAWA, Matsumoto-shi (JP); Masayuki TOKUNAGA, Matsumoto-shi (JP); Akinori MUROMACHI, Matsumoto-shi (JP)

(21) Appl. No.: 15/016,006

(22) Filed: Feb. 4, 2016

(30) Foreign Application Priority Data
Feb. 10, 2015 (JP) 2015-024220

(51) Int. Cl. B41J 2/165

(52) U.S. Cl. CPC B41J 2/16517; B41J 2002/16582

(57) ABSTRACT

A printer is provided with a discharging head that discharges ink, a supporting base that supports a medium, and a cap that receives an ink droplet discharged from the discharging head at the time of maintenance (flushing) implementation. The supporting base and the cap are moved between an ascending position (a supporting position and a flushing position) facing the discharging head along different moving routes and a retractable position. When positions of the supporting base and the cap are replaced with each other so as to perform the flushing during the printing, if the supporting base is firstly retracted from the supporting position, and then a first sensor which detects the supporting base is turned on, the cap ascends from the retractable position. After the flushing, if the cap firstly descends, and then a second sensor which detects the cap is turned on, the supporting base starts to ascend.

### BACKGROUND

1. Technical Field

The present invention relates to a liquid discharge apparatus and a control method of the liquid discharge apparatus which is provided with a supporting base supporting a medium and a maintenance unit such as a cap which is used for maintenance of a discharging head for discharging a liquid with respect to the medium.

2. Related Art

In the related art, as such type of liquid discharge apparatus, an ink jet type printing apparatus which is provided with a discharging head (a printing head) for discharging ink as a liquid has been known. The ink jet type printing apparatus is provided with a supporting base (an example of a supporting unit) which supports a medium such as a sheet to be transported and a discharging head which discharges ink from a nozzle to the medium supported by the supporting base. In addition, in order to prevent nozzle clogging in the discharging head, a maintenance device which performs maintenance of the discharging head in the middle the printing or during a standby state is provided in a printer (for example, refer to JP-A-2011-16314 and the like).

For example, a printing apparatus disclosed in JP-A-2011-16314 is provided with a platen unit (an example of a supporting unit) on which a recording sheet is placeable when being positioned facing an ink discharge surface of a line head, and a cap unit (an example of a maintenance unit) which can come in contact with the ink discharge surface when being positioned facing the ink discharge surface. The printing apparatus is also provided with a moving mechanism including a swing arm which swings the platen unit and the cap unit in a vertical direction so as to cause the platen unit or the cap unit to selectively face the ink discharge surface. The moving mechanism is configured such that the cap unit and the platen unit are moved in positions facing the line head by using one common motor.

Meanwhile, in order to obtain a high printing throughput, it is necessary to rapidly perform an operation of replacing positions of the platen unit and the cap unit with each other. However, each moving route of the platen unit and the cap unit is close to the line head side, and thus existence of an interference area, in which both units interfere with each other when both units pass though the moving route, is inevitable. Since the printing apparatus disclosed in JP-A-2011-16314 is driven by using one common motor, the platen unit and the cap unit are mechanically adjusted so as to be moved at timing when the platen unit and the cap unit do not interfere with each other by the moving mechanism including the swing arm.

However, in a case where the platen unit and the cap unit are independently driven by two power sources, if the platen unit and the cap unit are driven at the same time, the platen unit and the cap unit are likely to interfere with each other. On the other hand, in a case where one of the platen unit and the cap unit is moved first and then the other one starts to be moved, it is possible to avoid a case where both units interfere with each other; however, it takes relatively a long time to replace the positions both units with each other at the time of the maintenance. For this reason, it has been required to perform the replacement of the platen unit and the cap unit at a high speed while preventing the platen unit and the cap unit from interfering with each other. In addition, this kind of problem commonly occurs in a serial printer and in even a liquid discharge apparatus for discharging a liquid other than ink without limiting to the line printer.

### SUMMARY

An advantage of some aspects of the invention is to provide a liquid discharge apparatus and a control method of the liquid discharge apparatus which is capable of replacing the positions of a supporting unit and a maintenance unit with each other at a relatively high speed while preventing the supporting unit and the maintenance unit from interfering with each other.

Hereinafter, means of the invention and operation effects thereof will be described.

According to an aspect of the invention, there is provided a liquid discharge apparatus which discharges a liquid to a medium, including: a discharging head that discharges a liquid to the medium; a supporting unit that is capable of supporting the medium; a maintenance unit that is capable of performing maintenance on the discharging head; a moving mechanism that enables the supporting unit and the maintenance unit to move to a predetermined position facing the discharging head when positions of the supporting unit and the maintenance unit are replaced with each other; a first power source that causes the supporting unit to move; a second power source that causes the maintenance unit to move; and a control unit that controls the first power source and the second power source such that the positions of the supporting unit and the maintenance unit are replaced with each other, in which when the positions of the supporting unit and the maintenance unit are replaced with each other, the control unit includes a first period during which one or both of the supporting unit and the maintenance unit are moved, and a second period during which any one of the supporting unit and the maintenance unit is moved, and an interference area, in which the supporting unit and the maintenance unit interfere with each other when one or both of the supporting unit and the maintenance unit are moved, is set to be the second period.

According to this configuration, the positions of the supporting unit and the maintenance unit are replaced with each other by power from different power sources. For this reason, the supporting unit and the maintenance unit are independently controlled, but both units may interfere with each other in the vicinity of a predetermined position. The control unit controls each of the power sources such that the supporting unit and the maintenance unit are moved one by one in the interference area, and a moving operation of the supporting unit and a moving operation of the maintenance unit overlap with each other in at least a portion of period. Accordingly, it is possible for the positions of the supporting unit and the maintenance unit, which have different the power sources from each other, to be replaced with each other at a relatively rapid speed while preventing both units from interfering with each other.

In addition, in the liquid discharge apparatus, it is preferable that when the positions of the supporting unit and the maintenance unit are replaced with each other, the control unit controls movements of the supporting unit and the maintenance unit such that one of the supporting unit and the maintenance unit, which retracts from the predetermined position, initially passes through the interference area in a retracting direction, and then the other unit which starts to be moved toward the predetermined position passes through the interference area in a direction close to the discharging head before the one unit is completely retracted.

According to the configuration, when the positions of the supporting unit and the maintenance unit are replaced with each other, one of the supporting unit and the maintenance unit, which retracts from the predetermined position, initially passes through the interference area in a retracting direction, and then the other unit which starts to be moved toward the predetermined position passes through the interference area in a direction close to the discharging head before the one unit is completely retracted. Accordingly, it is possible for the positions of the supporting unit and the maintenance unit, which have different the power sources from each other, to be replaced with each other at a relatively rapid speed while preventing both units from interfering with each other.

In the liquid discharge apparatus, it is preferable that a detecting unit that detects the supporting unit and the maintenance unit at an activation position on each moving route thereof is further included, in which when the positions of the supporting unit and the maintenance unit are replaced with each other, the control unit controls one of the supporting unit and the maintenance unit, which retracts from the predetermined position, to firstly start to be moved, and then when the detecting unit detects that the one unit approaches the activation position, the control unit controls the other unit to start to be moved toward the predetermined position.

According to the configuration, when the positions of the supporting unit and the maintenance unit are replaced with each other, one of the supporting unit and the maintenance unit, which retracts from the predetermined position, firstly starts to be moved and the detecting unit detects that the one unit approaches the activation position, and then the other unit starts to be moved toward the predetermined position. Accordingly, it is possible for the positions of the supporting unit and the maintenance unit, which have different the power sources from each other, to be replaced with each other at a relatively rapid speed while preventing both units from interfering with each other, and it is not necessary to particularly adjust the speed so as to prevent the supporting unit and the maintenance unit from interfering with each other, and thus the control unit easily controls each of the power sources.

In the liquid discharge apparatus, it is preferable that at least the maintenance unit of the supporting unit and the maintenance unit have a variable average moving speed, and the control unit changes an activation timing when the maintenance unit is activated from a retractable position later than a time when the supporting unit starts to be moved from the predetermined position, in accordance with a speed of the maintenance unit.

According to the configuration, when the positions of the supporting unit and the maintenance unit are replaced with each other, the activation timing when the maintenance unit is activated from the retractable position with respect to the time when the supporting unit starts to be moved from the predetermined position is changed in accordance with the speed of the maintenance unit. Accordingly, even when at least the average moving speed of the maintenance unit is changed, it is possible for the positions of the supporting unit and the maintenance unit, which have different the power sources from each other, to be replaced with each other at a relatively rapid speed while preventing both units from interfering with each other.

In the liquid discharge apparatus, it is preferable that when one of the supporting unit and the maintenance unit, which starts to be moved from the predetermined position is in the interference area, the control unit causes the other unit to start to be moved.

According to the configuration, when one of the supporting unit and the maintenance unit, which starts to be moved from the predetermined position is in the interference area, the control unit causes the other unit to start to be moved. Accordingly, the time for replacing the positions of the supporting unit and the maintenance unit with each other can be further shortened.

In the liquid discharge apparatus, it is preferable that the maintenance unit includes a receiving portion which stores the liquid from the discharging head, and maintenance of the discharging head is performed by receiving the liquid discharged from the discharging head.

According to the configuration, the maintenance unit performs the maintenance of the discharging head by receiving the liquid discharged from the discharging head at a predetermined position facing the discharging head in the receiving portion. Accordingly, the replacing the positions of the supporting unit and the maintenance unit with each other is performed at a relatively high speed, and thus it is possible to complete the maintenance of receiving the liquid discharged from the discharging head in the receiving portion at a relatively high speed. For example, in a case where the maintenance is performed by interrupting a liquid discharging process with respect to the medium, it is possible to efficiently perform a liquid discharging process with respect to the medium.

In the liquid discharge apparatus, it is preferable that the moving route of the maintenance unit includes a movement area having a displacement component in a vertical direction, and the control unit changes the maximum speed when the maintenance unit ascends to the movement area in accordance with a level of the liquid which is stored in the maintenance unit.

According to the configuration, the maximum speed when the maintenance unit ascends to the movement area is changed in accordance with the level of the liquid which is stored in the maintenance unit. Accordingly, it is easy to prevent the liquid from spilling out from the receiving portion of the moving course of the maintenance unit.

In the liquid discharge apparatus, it is preferable that the moving route of the maintenance unit includes the movement area having the displacement component in the vertical direction, and the control unit further reduces the maximum speed of a course in which the maintenance unit is moved in the movement area in a case where the level of the liquid stored in the maintenance unit is a second liquid level which is higher than a first liquid level, as compared with a case where the level of the liquid stored in the maintenance unit is the first liquid level.

According to the configuration, the maximum speed of the course in which the maintenance unit is moved in the movement area becomes further reduced in the case where the level of the liquid stored in the maintenance unit is the second liquid level which is higher than the first liquid level, as compared with the case where the level of the liquid stored in the maintenance unit is the first liquid level. Accordingly, it is easy to prevent the liquid from spilling out from the receiving portion of the maintenance unit in the course in which the maintenance unit is moved in the movement area.

In the liquid discharge apparatus, it is preferable that the moving route of the maintenance unit includes the movement area having the displacement component in the vertical direction, and the control unit further reduces the maximum acceleration of the course in which the maintenance unit is moved in the movement area in the case where the level of the liquid stored in the maintenance unit is the second liquid level which is higher than the first liquid level, as compared with the case where the level of the liquid stored in the maintenance unit is the first liquid level.

According to the configuration, the maximum acceleration of the course in which the maintenance unit is moved in the movement area becomes further reduced in the case where the level of the liquid stored in the maintenance unit is the second liquid level which is higher than the first liquid level, as compared with the case where the level of the liquid stored in the maintenance unit is the first liquid level. Accordingly, it is less likely that the liquid stored in the maintenance unit spills out in the course in which the maintenance unit is moved in the movement area.

In the liquid discharge apparatus, it is preferable that the control unit further reduces the maximum value of an acceleration in the vertical direction in the course in which the maintenance unit is moved in the movement area in the case where the level of the liquid stored in the maintenance unit is the second liquid level, as compared with the case where the level of the liquid stored in the maintenance unit is the first liquid level.

According to the configuration, the maximum value of the acceleration in the vertical direction in the course in which the maintenance unit is moved in the movement area becomes further reduced in the case where the level of the liquid stored in the maintenance unit is the second liquid, as compared with the case where the level of the liquid stored in the maintenance unit is the first liquid level. For example, the maximum value of the acceleration in the vertical direction in the course in which the maintenance unit ascends to the movement area becomes further reduced in the case where the level of the liquid stored in the maintenance unit is the second liquid level, as compared with the case where the level of the liquid stored in the maintenance unit is the first liquid level. Accordingly, it is less likely that the liquid stored in the maintenance unit spills out in the moving course of the maintenance unit.

In the liquid discharge apparatus, it is preferable that the moving route of the maintenance unit includes the movement area having the displacement component in the vertical direction, and that the control unit reduces the maximum speed when the maintenance unit ascends to the movement area compared to the maximum speed when the maintenance unit descends to the movement area in a case where the level of the liquid stored in the maintenance unit is constant.

According to the configuration, the maximum speed when the maintenance unit ascends to the movement area becomes reduced compared to the maximum speed when the maintenance unit descends to the movement area in the case where the level of the liquid stored in the maintenance unit is constant. Accordingly, in the case where the liquid level of the liquid stored in the maintenance unit is constant, even in the case of the ascending course of the maintenance unit, it is possible to make the liquid barely spill out as in a descending course.

In the liquid discharge apparatus, it is preferable that the control unit further reduces the average moving speed of the maintenance unit in a case where the level of the liquid in the maintenance unit is the second liquid level which is higher than the first liquid level, as compared with the case where the level of the liquid stored in the maintenance unit is the first liquid level.

According to the configuration, the average moving speed of the maintenance unit becomes reduced in a case where the level of the liquid in the maintenance unit is the second liquid level which is higher than the first liquid level, as compared with the case where the level of the liquid stored in the maintenance unit is the first liquid level. Accordingly, even in the case where the level of the liquid in the maintenance unit is the second liquid level, it is possible to make the liquid stored in the maintenance unit barely spill out in the course of moving the maintenance unit as in the case where the level of the liquid in the maintenance unit is the first liquid level.

In the liquid discharge apparatus, it is preferable that the control unit counts the number of times of liquid discharge which is performed by the discharging head with respect to the maintenance unit, and the liquid level is obtained from the number of times of the liquid discharge.

According to the configuration, it is possible to relatively easily obtain the liquid level in the maintenance unit from the number of times of liquid discharge which is performed by the discharging head with respect to the maintenance unit.

According to another aspect of the invention, there is provided a control method of a liquid discharge apparatus including a discharging head which discharges a liquid to a medium, and a supporting unit which is capable of supporting the medium, a maintenance unit which is capable of performing maintenance on the discharging head, in which positions of the supporting unit and the maintenance unit are replaceable with each other with respect to predetermined position facing the discharging head, the method including: discharging the liquid from the discharging head on the medium supported by the supporting unit in a state where the supporting unit is disposed in predetermined position facing the discharging head; replacing positions of the supporting unit and the maintenance unit with each other when a predetermined timing is reached in the middle of discharging; performing maintenance of the discharging head by the maintenance unit; and replacing positions of the supporting unit and the maintenance unit with each other after completing the maintenance, in which in the replacings, a first period during which one or both of the supporting unit and the maintenance unit are moved, and a second period during which any one of the supporting unit and the maintenance unit is moved, are provided when positions of the supporting unit and the maintenance unit are replaced with each other, and an interference area, in which the supporting unit and the maintenance unit interfere with each other when one or both of the supporting unit and the maintenance unit are moved, is set to be the second period.

According to this method, it is possible to obtain the same effect as that of the liquid discharge apparatus.

### BRIEF DESCRIPTION OF THE DRAWINGS

The invention will be described with reference to the accompanying drawings, wherein like numbers reference like elements.

FIG. 1 is a side sectional view illustrating a printer in an embodiment.

FIG. 2 is a perspective view illustrating a driving control device of a supporting base and a cap.

FIG. 3 is a side view illustrating a driving control device in a state where the supporting base ascends and the cap descends.

FIG. 4 is side view illustrating the driving control device in a state where the supporting base descends and the cap ascends.

FIG. 5 is a block diagram illustrating an electrical configuration of the printer.

FIGS. 6A to 6C are schematic views illustrating an operation of an ascending and descending mechanism.

FIG. 7 is a schematic view illustrating a moving route of the supporting base and the cap.

FIG. 8 is a schematic view illustrating an example of a moving timing of the supporting base and the cap.

FIG. 9 is a graph illustrating an example of the moving timing of the supporting base and the cap by a relationship between a time and a position in the X direction.

FIG. 10 is a schematic view illustrating another example of the moving timing of the supporting base and the cap.

FIG. 11 is a graph illustrating another example of the moving timing of the supporting base and the cap by the relationship between the time and the position in the X direction.

FIG. 12 is a timing chart illustrating control of the supporting base and the cap.

FIGS. 13A and 13B are schematic side views illustrating an inclination of a liquid level in an ascending course of the cap.

FIGS. 14A and 14B are schematic side views illustrating an inclination of a liquid level in a descending course of the cap.

FIG. 15 is a schematic view illustrating a pendulum model of the liquid in the cap.

FIG. 16 is a schematic view illustrating the pendulum model illustrating the behavior of the liquid in the cap in accordance with the movement of the cap.

FIG. 17 is a graph illustrating a liquid level displacement with respect to a time for each ink amount in the ascending course of the cap.

FIG. 18 is a graph illustrating a state of a change of acceleration in a horizontal direction and acceleration in a vertical direction in the ascending course of the cap.

FIG. 19 is a graph illustrating a liquid level displacement with respect to a time for each ink amount in the descending course of the cap.

FIG. 20 is a graph illustrating a state of a change of acceleration in a horizontal direction and acceleration in a vertical direction in the descending course of the cap.

FIG. 21 is a graph illustrating a maximum liquid level displacement in accordance with the moving speed of the cap for each ink amount in the ascending course of the cap.

FIG. 22 is a graph illustrating the maximum liquid level displacement in accordance with the moving speed of the cap for each ink amount in the descending course of the cap.

FIG. 23 is a graph illustrating the limit speed at which the ink does not spill out from the cap in the ascending course and the limit speed at which the ink does not spill out from the cap in the descending course in terms of a relationship between the ink amount and the moving speed of the cap.

FIG. 24 is a graph illustrating the position and the speed of the cap with respect to a moving amount of an encoder (a motor rotation speed) when the cap is controlled.

FIG. 25 is a flow chart illustrating a flushing control routine.

FIG. 26 is a flow chart illustrating a portion of the flushing control.

FIG. 27 is a flow chart illustrating a portion of the flushing control.

### DESCRIPTION OF EXEMPLARY EMBODIMENTS

Hereinafter, as an embodiment of a liquid discharge apparatus, an ink jet type printer which is provided with a discharging head for discharging ink an example of the liquid, and prints (records) an image including characters and figures by discharging the ink onto a sheet which is an example of a medium will be described with reference to the drawings.

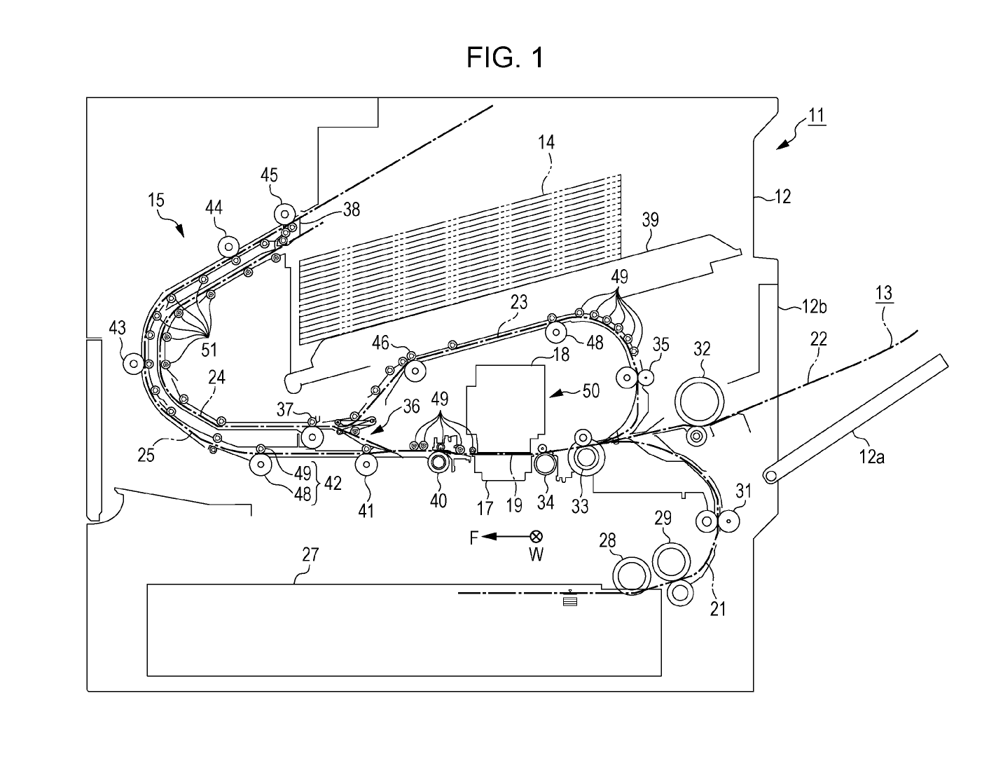

As illustrated in FIG. 1, as an example of a printing apparatus of the embodiment, a printer 11 is provided with a housing 12, and a transporting unit 15 which transports a sheet 14 and the housing 12 having a rectangular parallelepiped shape along a transporting route 13 illustrated by a dashed line in FIG. 1. Further, along the transporting route 13, a supporting base 17 as an example of a supporting unit for supporting the sheet 14 and a discharging head 18 which faces the supporting base 17 by interposing the transporting route 13 therebetween are fixedly disposed. In addition, in FIG. 1, a direction in which an area where the sheet 14 is interposed between the supporting base 17 and the discharging head 18 is transported along the transporting route 13 is referred to as a “transporting direction F”, and a direction which intersects with (particularly, orthogonal to) the “transporting direction F”, and is coincides with a longitudinal direction (a direction orthogonal to the sheet in FIG. 1) of each of the supporting base 17 and the discharging head 18 is referred to as a “width direction W”.

The discharging head 18 is a so called line head which is capable of discharging a plurality of ink droplets at the same time along the width direction W, and performs the printing by discharging the ink toward the sheet 14 which is transported to below the line head while being supported by the supporting base 17 with a predetermined gap from the discharging head 18. In addition, a position between the supporting base 17 and the discharging head 18 is referred to as a printing position 19 in the following description, in the transporting route 13. In addition, the transporting direction F indicates a transporting direction of the sheet 14 when passing through the printing position 19.

Further, the transporting route 13 is formed of a first feeding route 21 and a second feeding route 22 which are on the upstream side further than the printing position 19 in the transporting direction, a third feeding route 23, a branch route 24, and a discharge route 25 which are on the downstream side further than the printing position 19 in the transporting direction.

The first feeding route 21 is a route for connecting a sheet cassette 27 which can be inserted into and extracted from a bottom portion of the housing 12 and the printing position 19. Among a sheet group which is stored in the sheet cassette 27 in a stacked state, the sheet 14 which is on the top of the sheet group is fed by a pick-up roller 28, and the fed sheets 14 are separated one by one by a separating roller 29. In addition, the separated sheet 14 is transported to the printing position 19 by each of pairs of rollers 31, 33, and 34 which are positioned on the downstream side in the transporting direction.

In the second feeding route 22, the sheet 14 inserted to an inserting port 12b which is exposed by opening a cover 12a provided on one side surface of the housing 12 is transported to the printing position 19 by the pairs of rollers 32 to 34.

The third feeding route 23 is a route for inverting the extracted sheet 14 which is printed in the printing position 19 such that the sheet 14 is returned to the pair of rollers 33, and is used for inverting the sheet 14 at the time of double-sided printing. That is, a branching mechanism 36 is provided on the downstream side further than the printing position 19, and a pair of branching rollers 37 which are rotatable in both forward and reverse directions are provided on the branch route 24 which is branched from the discharge route 25 by the branching mechanism 36.

The discharge route 25 is a route for connecting an extracting port 38 for extracting the printed sheet 14, and the printing position 19. The sheet 14 which is extracted from the extracting port 38 by passing through the discharge route 25 is extracted onto a tray 39 in a stacked stated. Then, at least one (six pairs of transporting rollers in the embodiment) of pairs of transporting rollers 40 to 45 is provided on the discharge route 25. Further, pairs of transporting rollers 46 and 47 are provided on the third feeding route 23. The sheet 14 of which at least one surface is printed is transported by being interposed between each of the pairs of transporting rollers 40 to 47.

That is, each of the pairs of transporting rollers 40 to 47 is formed of a cylindrical driving roller 48 which is rotated based a driving force of a driving source, and a toothed roller 49 which is driven to rotate by the rotation of the driving roller 48. In addition, the toothed roller 49 is provided alone without being made a pair with the driving roller 48. The toothed roller 49 is provided on the side facing the printed surface which is the surface of the sheet 14 on which the printing is performed, on each of the third feeding route 23, the branch route 24, and the discharge route 25. On the other hand, the driving roller 48 is provided on the non-printed surface of the surface of the sheet 14, or is provided on the side facing the previously printed surface of the sheet 14 of which both sides are printed.

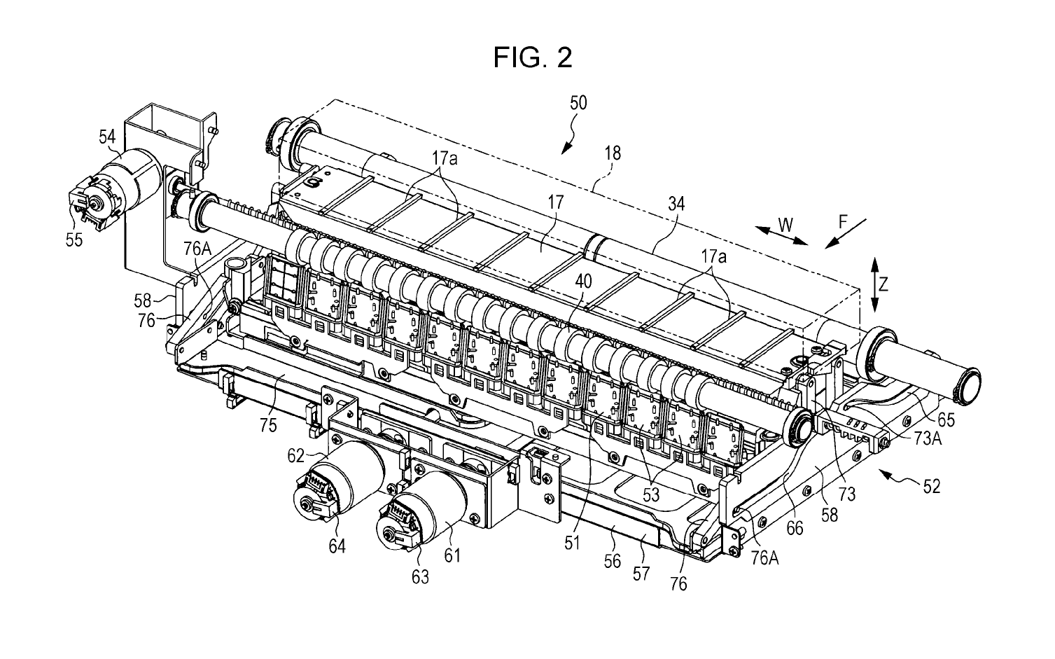

In addition, in the embodiment, a transporting unit 15 is formed of each of the rollers 28 and 29 and the pairs of rollers 31 to 35, the branching mechanism 36, and the pairs of rollers 37 and 40 to 47. In addition, it is possible to adjust the size of a gap between the discharging head 18 and the transporting route 13 by adjusting a height position of the discharging head 18 by an adjusting mechanism (not shown). The printer 11 of the embodiment perform the printing by discharging the ink discharged from the discharging head 18 to the transported sheet 14, and is provided with a printing unit 50, illustrated in FIG. 2, which performs maintenance with respect to the discharging head 18 during the printing.

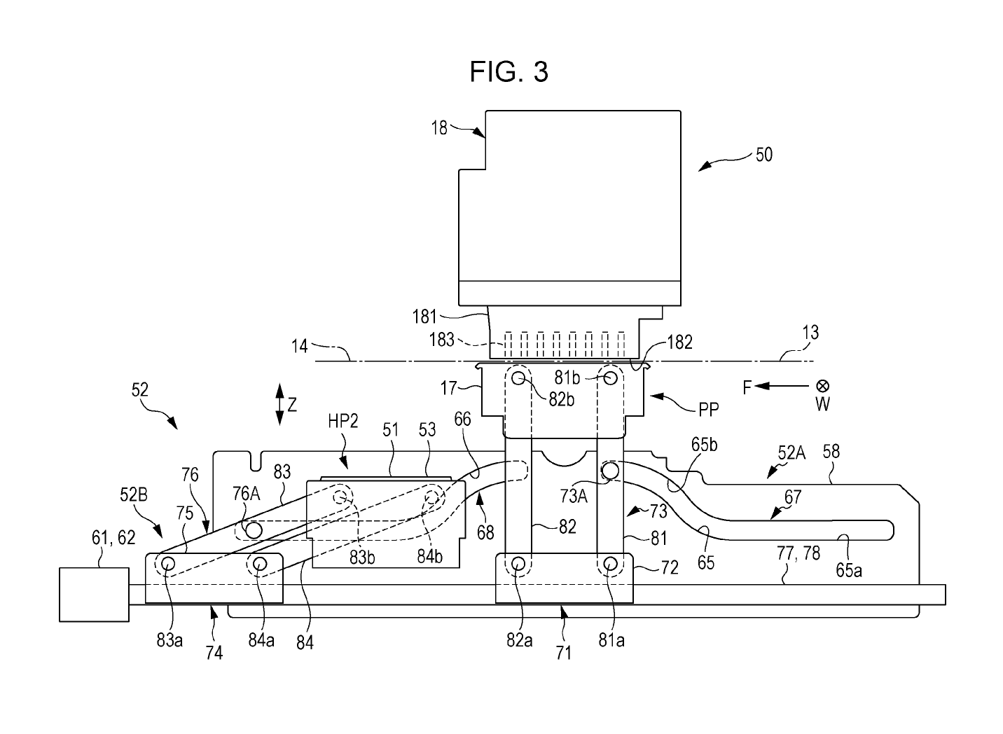

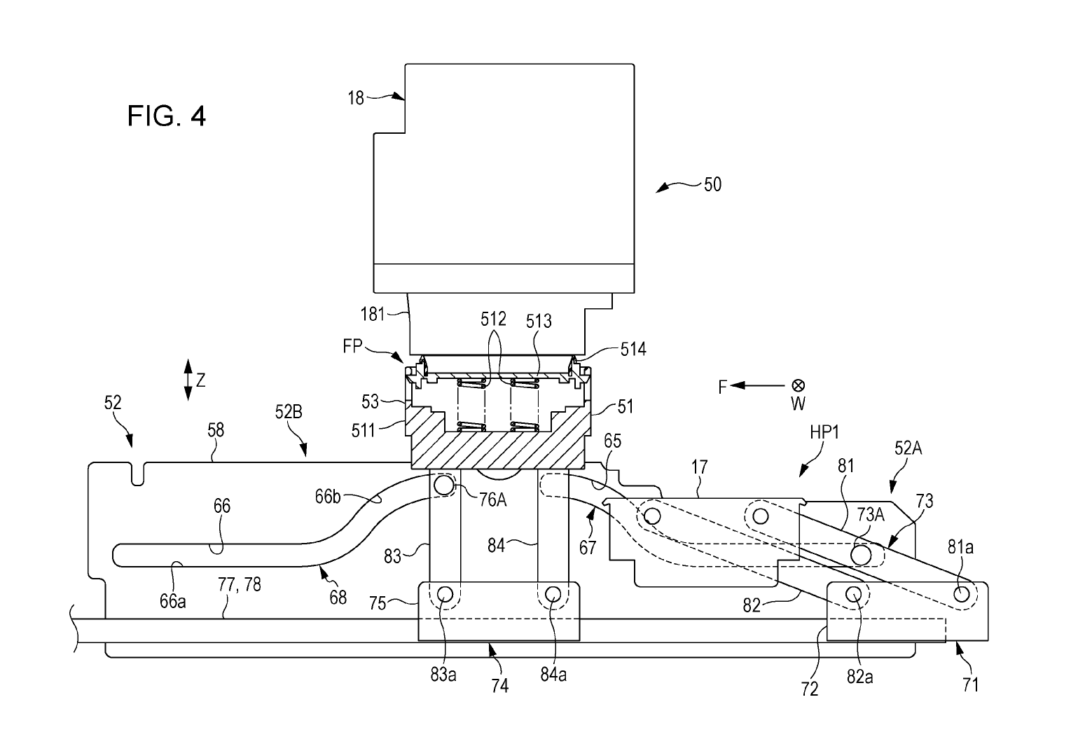

As illustrated in FIG. 2, the printing unit 50 is provided with the supporting base 17 having a long-plate shape, the discharging head 18 (the head unit) which is formed of the line head indicated by two-dot chain line in FIG. 2, the cap 51 (the cap unit) which is capable of capping a nozzle opening surface (a bottom surface in FIG. 2) of the discharging head 18, and the moving mechanism 52 which causes the supporting base 17 and the cap 51 to move. The discharging head 18 is formed of a so called multi-head type ling head in which a plurality of unit heads 181 (refer to FIG. 3 and FIG. 4) are arranged in one or a plurality of rows. The cap 51 includes a plurality of cap portions 53 which can come in contact with each of the nozzle opening surfaces for each of the plurality of unit heads 181. In the embodiment, the plurality of unit heads 181 are arranged in a row, and thus the plurality of cap portion 53 forming the cap 51 are arranged in a row in accordance with the unit head 181.

A pair of transporting rollers 34 and a pair of extracting rollers 40 are respectively disposed on the upstream side and the down side which interpose the discharging head 18 therebetween in the transporting direction F, in the direction in which an axial direction coincides with the width direction W intersecting with each of the transporting direction F. Both pairs of rollers 34 and 40 are connected to a transporting motor 54 corresponding to a power source via a power transferring mechanism (a wheel train which is not shown). The pairs of rollers 34 and 40 are rotated by the power of the transporting motor 54. In the transporting motor 54, an encoder 55 which is capable of outputting a pulse signal having pulses which are proportional to the amount of rotations is provided.

The supporting base 17 is disposed in a position between the pair of transporting rollers 34 and the pair of extracting rollers 40 in the transporting direction F in a state where an upper surface (a supporting surface) of the supporting base 17 faces the nozzle opening surface of the discharging head 18 (the unit head 181). The supporting base 17 has at least the length which is sufficient for supporting the sheet 14 over an assumed maximum width (an assumed maximum width of the sheet) of the sheet which is a target to be printed by discharging the ink droplet from the discharging head 18. On the upper surface of the supporting base 17, a plurality of ribs 17A protrude at a predetermined interval in the longitudinal direction. The sheet 14 in the middle of the printing is transported to the transporting direction F in a state of being supported by the plurality of ribs 17A. On the other hand, the cap 51 includes the plurality of cap portion 53 corresponding to each of the plurality of unit heads 181 forming the discharging head 18. The plurality of cap portion 53 are integrally attached with each other in a state of being arranged in the same pattern as that of the plurality of unit heads 181.

In the printing unit 50 of the embodiment, the moving mechanism 52 which is capable of replacing one of the supporting base 17 and the cap 51 which is disposed in a predetermined position (an ascending position as an example) facing the discharging head 18 is provided. The moving mechanism 52 is disposed on the side lower than the transporting route of the sheet 14, that is, the moving mechanism 52 is disposed on the side lower than the supporting base 17 which is disposed in the supporting position at the time of the printing as illustrated in FIG. 2. The moving mechanism 52 is provided with a first motor 61 which is an example of a first power source causing the supporting base 17 to move, and a second motor 62 which is an example of a second power source causing the cap 51 to move. Both motors 61 and 62 are electric motors which are rotatable in both forward and reverse directions. In the first motor 61, an encoder 63 which is capable of outputting a pulse signal having pulses which are proportional to the amount of rotations is provided. In addition, in the second motor 62, an encoder 64 which is capable of outputting a pulse signal having pulses which are proportional to the amount of rotations is provided.

The moving mechanism 52 is provided a supporting frame 56 which supports the supporting base 17 and the cap 51 in an ascending and descending manner. The supporting frame 56 includes a bottom plate 57 and a pair of side plates 58 which are disposed to face both sides of the bottom plate 57 in the width direction W. On the pair of side plates 58, a first cam hole 65 (a guide hole) which is formed of a long hole in a predetermined shape, and is capable of guiding the supporting base 17 along a predetermined moving route, and a second cam hole 66 which is formed of a long hole in a predetermined shape, and is capable of guiding the cap 51 along a predetermined moving route.

As illustrated in FIG. 3 and FIG. 4, the moving mechanism 52 is provided with a slider 72 (hereinafter, also referred to as “a supporting base-side slider 72”) which is slidingly moved by the rotating force of the first motor 61 via a ball screw mechanism 71. The supporting base 17 is supported by the slider 72 via a pair of link mechanisms 73 (refer to FIG. 3 and FIG. 4) in an ascending and descending manner. In the link mechanism 73, the pin 73A which is guided along the first cam hole 65 is provided in a state of being inserted into the first cam hole 65. The first cam hole 65 functions as a cam, and the pin 73A functions as a cam follower. In addition, a cam mechanism 67 is formed of the first cam hole 65 and the pin 73A.

In addition, as illustrated in FIG. 3 and FIG. 4, the moving mechanism 52 is provided with a slider 75 (hereinafter, also referred to as a cap-side slider 75) which is slidingly moved by the rotating force of the second motor 62 via a ball screw mechanism 74. The cap 51 is supported by the slider 75 via a pair of link mechanisms 76 in an ascending and descending manner. In the link mechanism 76, the pin 76A which is guided along the second cam hole 66 is provided in a state of being inserted into the second cam hole 66. The second cam hole 66 functions as a cam, and the pin 76A functions as a cam follower. In addition, the cam mechanism 68 is formed of the second cam hole 66 and the pin 76A.

In addition, in a course in which the supporting base-side slider 72 is slidingly moved in a direction parallel with the transporting direction F, when the pin 73A of the link mechanism 73 is guided along the first cam hole 65 by driving the first motor 61, the supporting base 17 is capable of ascending and descending in accordance with the movement in the horizontal direction in the middle of the above course. In addition, in a course in which the cap-side slider 75 is slidingly moved in a direction parallel with the transporting direction F, when the pin 76A is guided to the link mechanism 76 along the second cam hole 66 by driving second motor 62 in a state of being inserted into the second cam hole 66, the cap 51 is capable of ascending and descending in accordance with the movement in the horizontal direction in the middle of the above course.

As illustrated in FIGS. 2 to 4, in a state where the supporting base 17 is disposed in a supporting position PP which faces the discharging head 18 with a predetermined gap therebetween, the cap 51 is disposed in a retractable position HP2 (refer to FIG. 3) which does not face the discharging head 18. In addition, in a state where the cap 51 is disposed in a flushing position FP (refer to FIG. 4) which faces the discharging head 18 with a predetermined gap therebetween, the supporting base 17 is disposed in the retractable position HP2 which does not face the discharging head 18.

As illustrated in FIG. 3, a plurality of nozzles 183 for discharging ink are formed on a nozzle opening surface 182 which faces the transporting route 13 of each of the unit heads 181 forming the discharging head 18. For example, in the configuration in which the plurality of unit heads 181 are arranged in a row in the width direction W, the plurality of unit heads 181 are arranged in parallel with each other at an oblique posture in which an angle of the nozzle row direction with respect to the transporting direction F becomes an acute angle. The cap portions 53 forming the cap 51 are form an enclosed space to which the nozzle 183 is directed by coming in contact with the nozzle opening surface 182 of the unit head 181.

As illustrated in FIG. 4, the cap portion 53 is provided with a cap holder 511 which is formed into a bottomed rectangular box shape, and of which the upper side is opened, and a cap forming member 513 which is formed into a bottomed rectangular box shape, and is slidably engaged with the cap holder 511 in a state being biased upward by at least one (two compression springs in the embodiment) of compression spring 512. A rectangular cap frame 514 (a lid portion) which is formed of an elastic material such as rubber is fixed to an upper end portion of the cap forming member 513.

Next, the moving mechanism 52 will be described in detail with reference to FIG. 3 and FIG. 4.

As illustrated in FIG. 3 and FIG. 4, the moving mechanism 52 is provided with a first moving mechanism 52A for moving the supporting base 17, and a second moving mechanism 52B for moving the cap 51. First, the first moving mechanism 52A will be described. The first moving mechanism 52A is provided with a ball screw mechanism 71 which converts an output rotation of the first motor 61 into the linear motion of the slider 72. The ball screw mechanism 71 is provided with a screw shaft 77 which is coupled with a driving shaft of the first motor 61 on the same shaft via a coupling (not shown), and the slider 72 into which the screw shaft 77 is screwed via a plurality of balls (not shown). The slider 72 is forwardly moved from the first position illustrated in FIG. 4 to the second position illustrated in FIG. 3 by forward rotation of the screw shaft 77 when the first motor 61 is forwardly driven, and the slider 72 is reversely moved from the second position to the first position by reverse rotation of the screw shaft 77 when the first motor 61 is reversely driven.

As illustrated in FIG. 3 and FIG. 4, the link mechanism 73 includes a pair of first link members 81 and 82 which are interposed between the slider 72 and the supporting base 17 such that both of the slider 72 and the supporting base 17 are linked with each other so as to be relatively movable. A base end portion of each of the pair of first link members 81 and 82 is rotatably connected to the slider 72 via shaft portions 81a and 82a, and a tip end portion thereof is rotatably connected to the supporting base 17 via shaft portions 81b and 81b. The pin 73A is fixed to substantially the center position of the link member 81, of the pair of first link members 81 and 82, which is disposed on the retractable position side of the supporting base 17 in a longitudinal direction, and the pin 73A is inserted into the first cam hole 65. The first cam hole 65 includes a horizontal guide portion 65a which horizontally extends from one end portion on the retractable position HP1, and an oblique shaped guide portion 66b which extends obliquely upward from the other end portion of the horizontal guide portion 65a.

When the first motor 61 is forwardly driven, and the slider 72 is forwardly moved from the first position to the second position, in the course in which the pin 73A is guided to the horizontal guide portion 65a, the supporting base 17 is horizontally moved (in a horizontal moving course), and in the course in which the pin 73A is guided to the oblique shaped guide portion 65b, the supporting base 17 is moved obliquely upward (a horizontal and vertical moving course). In a stage where the pin 73A approaches a terminal point of the oblique shaped guide portion 65b, the pair of link members 81 and 82 are still at the obliquely inclined posture angle, and when the slider 72 is further moved forward, the pair of link members 81 and 82 are raised to be an almost upright state as illustrated in FIG. 3, and in this raising course, the supporting base 17 ascends almost in the vertical direction (a vertical moving course). As such, in the course in which the supporting base 17 is moved from the supporting position PP to the retractable position HP1 in an ascending manner, the supporting base 17 is moved in the horizontal direction in the horizontal moving course, obliquely ascends while being displaced in both of the horizontal direction and the vertical direction in the horizontal and vertical moving course (an oblique moving course), and ascends almost in the vertical direction in the vertical moving course. In addition, in the course in which the supporting base 17 is moved from the supporting position PP to the retractable position HP1 in a descending manner, the supporting base 17 follows a reverse route at the time of the ascending movement, descends almost in the vertical direction in the vertical moving course, obliquely descends in the horizontal and vertical moving course (the oblique moving course), and is moved in the horizontal direction in the horizontal moving course.

Next, a second moving mechanism 52B will be described. The second moving mechanism 52B is provided with a ball screw mechanism 74 which converts an output rotation of the second motor 62 into the linear motion of the slider 75. The ball screw mechanism 74 is provided with a screw shaft 78 which is coupled with a driving shaft of the second motor 62 on the same shaft via a coupling (not shown), and the slider 75 into which the screw shaft 78 is screwed via a plurality of balls (not shown). The slider 75 is forwardly moved from the first position illustrated in FIG. 3 to the second position illustrated in FIG. 4 by forward rotation of the screw shaft 78 when the second motor 62 is forwardly driven, and the slider 75 is reversely moved from the second position to the first position by reverse rotation of the screw shaft 78 when the second motor 62 is reversely driven.

As illustrated in FIG. 3 and FIG. 4, the link mechanism 76 includes a pair of second link members 83 and 84 which are interposed between the slider 75 and the cap 51 such that both of the slider 75 and the cap 51 are linked with each other so as to be relatively movable. A base end portion of each of the pair of second link members 83 and 84 is rotatably connected to the slider 75 via shaft portions 83a and 84a, and a tip end portion thereof is rotatably connected to the cap 51 via shaft portions 83b and 84b. The pin 76A is fixed to substantially the center position of the link member 83, of the pair of second link members 83 and 84, which is disposed on the retractable position side of the cap 51 in a longitudinal direction, and the pin 76A is inserted into the second cam hole 66. In addition, the second cam hole 66 includes a horizontal guide portion 66a which horizontally extends from one end portion on the retractable position HP2, and an oblique shaped guide portion 66b which extends obliquely upward from the other end portion of the horizontal guide portion 66a.

When the second motor 62 is forwardly driven, and the slider 75 is forwardly moved from the first position to the second position, in the course in which the pin 76A is guided to the horizontal guide portion 66a, the cap 51 is horizontally moved (in a horizontal moving course), and in the course in which the pin 76A is guided to the oblique shaped guide portion 66b, the cap 51 is moved obliquely upward (a horizontal and vertical moving course). In a stage where the pin 76A approaches a terminal point of the oblique shaped guide portion 66b, the pair of link members 83 and 84 are still at the obliquely inclined posture angle, and when the slider 75 is further moved forward, the pair of the second link members 83 and 84 are raised to be an almost upright state as illustrated in FIG. 4, and in this raising course, the cap 51 ascends almost in the vertical direction (a vertical moving course). As such, in the course in which the cap 51 is moved from the flushing position FP to the retractable position HP2 in an ascending manner, the cap 51 is moved in the horizontal direction in the horizontal moving course, obliquely ascends while being displaced in both of the horizontal direction and the vertical direction in the horizontal and vertical moving course (an oblique moving course), and ascends almost in the vertical direction in the vertical moving course. In addition, in the course in which the cap 51 is moved from the flushing position FP to the retractable position HP2 in a descending manner, the cap 51 follows a reverse route at the time of the ascending movement, descends almost in the vertical direction in the vertical moving course, obliquely descends in the horizontal and vertical moving course (the oblique moving course), and is moved in the horizontal direction in the horizontal moving course.

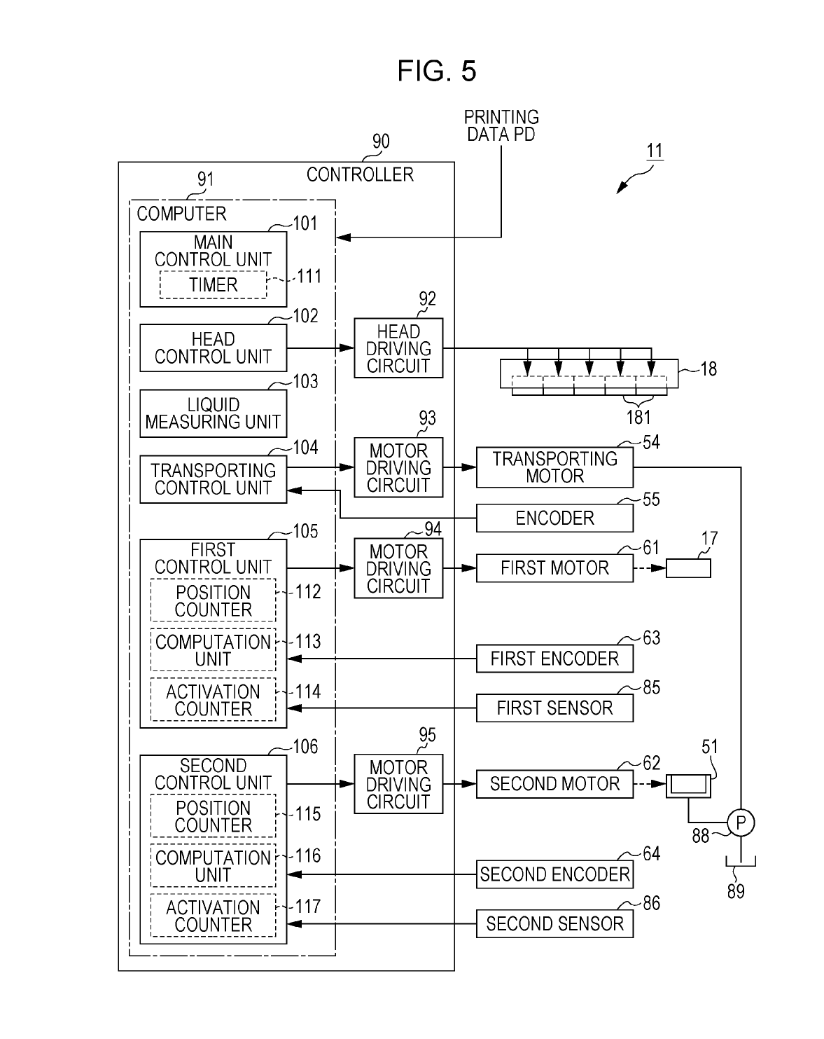

Next, an electrical configuration of the printer 11 will be described with reference to the FIG. 5. As illustrated in FIG. 5, as an input system, a transporting encoder 55, a first encoder 63, a second encoder 64, a first sensor 85, and a second sensor 86 are electrically connected to a controller 90 as an example of the control unit, which is provided in the printer 11. In addition, as an output system, the discharging head 18, the transporting motor 54, the first motor 61, and the second motor 62 are connected to the controller 90.

The encoder 55 outputs a pulse signal having pulses which are proportional to the amount of rotations of the transporting motor 54, that is, a pulse signal having pulses which are proportional to the transporting distance of the sheet 14. In addition, the first encoder 63 outputs a pulse signal having pulses which are proportional to the amount of rotations of the first motor 61, that is, a pulse signal having pulses which are proportional to the moving amount of the supporting base 17. In addition, the second encoder 64 outputs a pulse signal having pulses which are proportional to the amount of rotations of the second motor 62, that is, a pulse signal having pulses which are proportional to the moving amount of the cap 51.

The first sensor 85 illustrated in FIG. 5 is, for example, a position sensor for detecting that the supporting base 17 is in a first position (an activation position) on the moving route, and outputs a detection signal by detecting a detected portion (not shown) which is fixed to the supporting base 17 when the supporting base 17 approaches the first position in the middle of being moved from the supporting position PP to the retractable position HP1. An activation time during the movement of the cap 51 from the retractable position HP2 to the flushing position FP is the time when the supporting base 17 approaches the first position. The first sensor 85 detects the time when the supporting base 17 approaches the first position as the activation time during the movement of the cap 51 from the retractable position HP2 to the flushing position FP.

The second sensor 86 illustrated in FIG. 5 is, for example, a position sensor for detecting that the cap 51 is in a second position (an activation position) on the moving route, and outputs a detection signal by detecting a detected portion (not shown) which is fixed to the cap 51 when the cap 51 approaches the second position in the middle of being moved from the flushing position FP to the retractable position HP2. An activation time during the movement of the supporting base 17 from the retractable position HP1 to the supporting position PP is the time when the cap 51 approaches the second position. The second sensor 86 detects the time when the cap 51 approaches the second position as the activation time during the movement of the supporting base 17 from the retractable position HP1 to the supporting position PP.

The controller 90 illustrated in FIG. 5 is provided with a computer 91, a head driving circuit 92, and motor driving circuits 93 to 95. The computer 91 drives and controls the transporting motor 54, the first motor 61, and the second motor 62 via each of the motor driving circuits 93 to 95 during the printing control. Specifically, the computer 91 drives only the rotating speed which commands the motors 54, 61, and 62 and the commanded driving amount by outputting each command value to each of the motor driving circuits 93 to 95 (for example, a pulse width modulation (PWM) value).

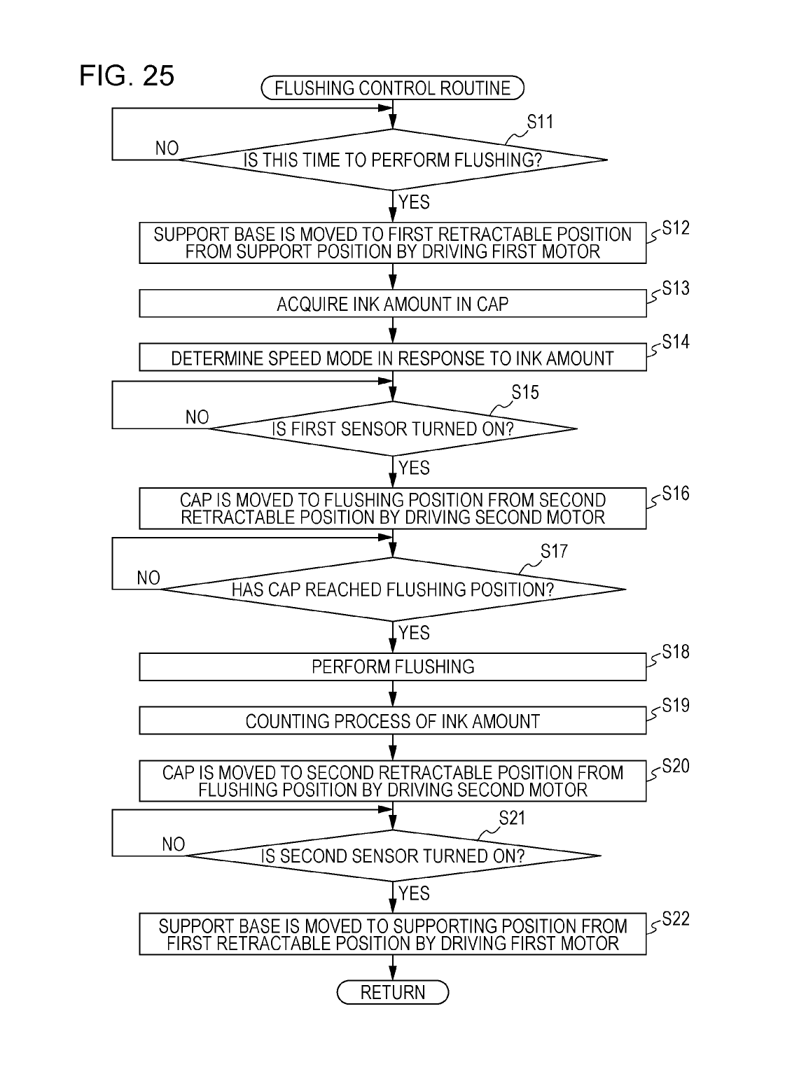

In addition, the computer 91 illustrated in FIG. 5 is provided with a central processing unit (CPU), an application specific IC (ASIC), a RAM, and a non-volatile memory (which are not shown). In the non-volatile memory, various programs including a flushing control routine (refer to FIG. 25), and required reference data and setting data such as speed control data which defines a speed profile when moving the supporting base 17 and the cap 51 are stored. In the RAM, a program or items of data of various computation results performed by the CPU is temporarily stored. The CPU performs the programs read from the non-volatile memory so as to control a printing process which is performed by the printing unit 50 in the printer 11, the movement of the supporting base 17 toward the supporting position PP and the retraction of the supporting base 17 from the supporting position PP, and the movement of the cap 51 toward the flushing position FP and the retraction of the cap 51 from the flushing position FP.

As illustrated in 5, the computer 91 is provided with various functional units provided therein by performing the programs. That is, the computer 91 is provided with a main control unit 101, a head control unit 102, a liquid measuring unit 103, a transporting control unit 104, a first control unit 105, and a second control unit 106, as the functional units.

The main control unit 101 instructs the respective units 102 to 106 to perform a process or control which is responsible thereto, and manages various controls required for the printing. The main control unit 101 is provided with a timer 111. The timer 111 counts an elapsed time from the time of the previous flushing operation. The main control unit 101 recognizes that a flushing implementation time (an example of the predetermined period) is reached when the time counted by the timer 111 reaches a setting time and thus a flushing condition is established.

The head control unit 102 performs a discharge control of causing the discharging head 18 to discharge an ink droplet from the nozzle 183. In addition, the head control unit 102 performs flushing (idle discharge) in which the ink droplets, which are not related to the printing on a regular or irregular period during the printing, are discharged from the entire nozzles 183 of the discharging head 18. The thickened ink or bubbles in the nozzle 183 are discharged by performing the flushing, and thus it is possible to prevent the occurrence of blocking of the nozzle 183 which has less discharge frequencies during the printing, and thereby suppressing the deterioration of printing quality.

The main control unit 101 instructs the first control unit 105 and the second control unit 106 to perform replacing control in such a manner that the supporting base 17 is retracted from the supporting position PP to the retractable position HP1, and the cap 51 is moved from the retractable position HP2 to the flushing position FP when the time counted by the timer 111 reaches and thus the setting time reaches the flushing implementation time (an example of a predetermined time). That is, the main control unit 101 instructs the first and second control units 105 and 106 to perform the replacing control in such a manner that the positions of the supporting base 17 and the cap 51 are replaced with each other with respect to a predetermined position (an ascending position) facing the discharging head 18. In addition, when receiving a replacement completion notice that the positions of the supporting base 17 and the cap 51 are completely replaced with each other with respect to the predetermined position, from the first and second control units 105 and 106, the main control unit 101 instructs the head control unit 102 to perform the flushing (the idle discharge). That is, the main control unit 101 instructs the head control unit 102 to perform the flushing after the cap 51 is disposed in the flushing position FP facing the nozzle opening surface 182 of the discharging head 18.

The liquid measuring unit 103 measures the level of the liquid (the ink amount) which is stored in the cap 51. The cap 51 in the example is connected to a suction pump 88 via a tube. In the example, the transporting motor 54 possesses the power source of the suction pump 88, and the transporting motor 54 is rotated to, for example, the direction reverse to the rotation direction when the sheet 14 is transported such that the suction pump 88 is driven and the ink stored in the cap 51 is discharged to a waste liquid tank 89. The liquid measuring unit 103 is provided with a counter (not shown) which is reset whenever the liquid (ink) is removed from the cap 51 by driving the suction pump 88, and counts the number of times of the flushing (the number of times of the idle discharge) by using the counter so as to measure the level of the liquid stored in the cap 51 based on the counted value. As such, the liquid measuring unit 103 measures the level of the liquid stored in the cap 51 based on the number of times of the flushing which is counted by the counter which is reset whenever the liquid (ink) is removed from the cap 51. Here, in the flushing, the respective nozzles 183 of the entire discharging head 18 discharge the ink the same number of times at the same liquid level, and thus the level of the liquid stored in the cap 51 is proportional to the number of times of the flushing. In addition, it is possible to regard that the level of the liquid stored in each of the plurality of cap portions 53 is the same, and thus the liquid level which is measured by the liquid measuring unit 103 indicates the level of the liquid stored in each of the cap portions 53.

The transporting control unit 104 illustrated in FIG. 5 drives and controls the transporting motor 54 via a motor driving circuit 93, and rotatably drives each pair of rollers 33, 34, and 40 forming the transporting unit 15 so as to transport the sheet 14. The transporting control unit 104 controls a speed of the transporting motor 54 such that the sheet 14 in the middle of being printed in which the ink droplet is discharged from the discharging head 18 is transported at a constant speed in accordance with a printing mode at that time. In addition, when the transporting control unit 104 receives an instruction from the main control unit 101 to drive the suction pump 88, the transporting control unit 104 drives the transporting motor 54 for driving the suction pump 88 in the rotation direction. The liquid (waste ink) which is stored in the cap 51 is discharged to the waste liquid tank 89 by driving the suction pump 88. In addition, whenever the liquid stored in the cap 51 is discharged by driving the suction pump 88, the main control unit 101 notifies the fact of the liquid measuring unit 103. The liquid measuring unit 103 resets a liquid level counter whenever the notification is received from the main control unit 101. For this reason, the liquid level counter counts the counted value corresponding to the level of the liquid which is currently stored in the cap 51.

The first control unit 105 illustrated in FIG. 5 drives and controls the first motor 61 which is the power source of the supporting base 17, and controls the movement of the supporting base 17. The first control unit 105 is provided with a position counter 112 for obtaining a position of the supporting base 17, a computation unit 113 for performing various types of computations which determine the activation timing of the supporting base 17, and an activation counter 114 for obtaining the fact that the supporting base 17 approaches the computed activation timing.

Here, in the embodiment, when one of the supporting base 17 and the cap 51, which is disposed in a predetermined position (the ascending position) facing the nozzle opening surface 182 of the discharging head 18, is moved first, and approaches the activation position in the middle of the retractable position, the other one of the supporting base 17 and the cap 51 starts to be moved. Then, in the embodiment, examples of a method of obtaining the fact that one of the supporting base 17 and the cap 51 approaches the activation position include a first method of causing a sensor to detect that one of the supporting base 17 and the cap 51 which descends from the predetermined position approaches the activation position, and a second method of monitoring whether or not one of the supporting base 17 and the cap 51 which descends from the predetermined position approaches the activation position by computing the activation position based on data of the speed and distance.

In the first method, when the cap 51 approaches the second position in the middle of being moved from the flushing position FP to the retractable position HP2 on the moving route, and a detection signal is input to the first control unit 105 from the second sensor 86, the first control unit 105 causes the supporting base 17 to move from the retractable position HP1 to the supporting position PP. That is, when the detection signal is input to the first control unit 105 from the second sensor 86 while the cap 51 descends from the flushing position FP, the first control unit 105 drives the first motor 61 via the motor driving circuit 94 such that the supporting base 17 starts to be moved from the retractable position HP1 to the supporting position PP. After starting the movement of the supporting base 17, the first control unit 105 controls the speed of the first motor 61 in which a predetermined speed profile. In addition, the first control unit 105 uses the computation unit 113 and the activation counter 114 in the second method.

The position counter 112 counts a pulse edge of the pulse signal from the first encoder 63. The first control unit 105 resets the position counter 112 when detecting that the supporting base 17 approaches the retractable position HP1 based on the fact that the supporting base 17 having approached the retractable position HP1 abuts on a stopper (not shown) and thus a load (for example, a current value) applied to the first motor 61 exceeds a threshold. For this reason, the position counter 112 counts an encoder moving amount EM1 as a counted value, which represents a current position (hereinafter, referred to as “a supporting base position P1”) of the supporting base 17 on the moving route. Note that, an origin of the aforementioned current position is the retractable position HP1 of the supporting base 17. Accordingly, the first control unit 105 obtains the supporting base position P1 based on the encoder moving amount EM1 which is the counted value of the position counter 112.

In addition, when the second method is employed, the first control unit 105 uses the computation unit 113 and the activation counter 114. The computation unit 113 computes the activation position of the cap 51 which determines the activation timing of the supporting base 17. The activation position is computed to determine the timing in which the supporting base 17 in the middle of the movement does not interferes with the cap 51 in descending. The computation unit 113 reads information on the moving speed of the cap 51 used for the above computation from the memory stored in the computer 91.

The activation counter 114 obtains the position of the cap 51 in the descending course from the second control unit 106, sets a residual moving amount of the cap 51 until the cap 51 approaches the activation position to which the supporting base 17 is to be moved, and counts down the counted values indicating the residual moving amount in accordance with the moving amount of the cap 51 which is obtained from the second control unit 106. When the counted value of the activation counter 114 reaches “0” (zero), the first control unit 105 causes the movement of the supporting base 17 from the retractable position HP1 by driving the first motor 61 via the motor driving circuit 94. After starting the movement of the supporting base 17, the first control unit 105 controls the speed of the first motor 61 in accordance with a predetermined speed profile.

In addition, the second control unit 106 illustrated in FIG. 5 drives and controls the second motor 62 which is the power source of the cap 51, and controls the movement of the cap 51. At this time, the moving speed of the cap 51 is controlled in accordance with the level of the liquid stored in the cap 51. Specifically, the moving speed of the cap 51 becomes slower as the level of the liquid stored in the cap 51 is high. In this regards, the speed of the cap 51 in the horizontal and vertical moving course, and the vertical moving course becomes slower as the liquid level is high while the speed of the cap 51 in the horizontal moving course is not changed. With this, as the level of the liquid stored in the cap 51, the average moving speed the cap 51 in the ascending course becomes slower. The second control unit 106 is provided with a position counter 115 for obtaining the position of the cap 51, a computation unit 116 for performing various types of computations which determine the activation timing of the activation timing of the cap 51 and the average moving speed of the cap 51, and an activation counter 117 for obtaining the fact that the cap 51 approaches the computed activation timing.

In the first method, when the supporting base 17 approaches the first position in the middle of being moved from the supporting position PP to the retractable position HP1 on the moving route, and a detection signal is input to the second control unit 106 from the first sensor 85, the second control unit 106 causes the cap 51 to move from the retractable position HP2 to the flushing position FP. That is, when the detection signal is input to the second control unit 106 from the first sensor 85 while the supporting base 17 descends from the supporting position PP, the second control unit 106 drives the second motor 62 via the motor driving circuit 95 such that the cap 51 starts to be moved from the retractable position HP2 to the supporting position PP. After starting the movement of the cap 51, the second control unit 106 controls the speed of the second motor 62 in which a speed profile which is selected in accordance with the level of the liquid stored in the cap 51. In addition, the second control unit 106 uses the computation unit 116 and the activation counter 117 in the second method.

The position counter 115 counts a pulse edge of the pulse signal from the second encoder 64. The second control unit 106 resets the position counter 115 when detecting that the cap 51 approaches the retractable position HP2 based on the fact that the cap 51 having approached the retractable position HP2 abuts on a stopper (not shown) and thus a load (for example, a current value) applied to the second motor 62 exceeds a threshold. For this reason, the position counter 115 counts an encoder moving amount EM2 as a counted value, which represents a current position (hereinafter, referred to as “a supporting base position P2”) of the cap 51 on the moving route. Note that, an origin the aforementioned current position is the retractable position HP2 of the cap 51. Accordingly, the second control unit 106 obtains the supporting base position P2 based on the encoder moving amount EM2 which is the counted value of the position counter 115.

In addition, when the second method is employed, the second control unit 106 uses the computation unit 116 and the activation counter 117. The computation unit 116 computes the activation position of the supporting base 17 which determines the activation timing of the cap 51. In addition, in the ascending course of the cap 51, the computation unit 116 computes the moving speed of the cap 51 in accordance with the level of the liquid stored in the cap 51. In the embodiment, in the ascending course of the cap 51, the speed of the cap 51 in the horizontal and vertical moving course, and the vertical moving course becomes slower as the level of the liquid stored in the cap is high while the speed of the cap 51 in the horizontal moving course is not changed. That is, as the level of the liquid stored in the cap 51, the average moving speed the cap 51 in the ascending course becomes slower. At this time, the activation position is computed by considering that the moving speed of the cap 51 is changed in accordance with the level of the liquid stored in the cap 51. The activation position is computed to determine the timing in which the cap 51 in the middle of the movement does not interferes with the supporting base 17 in descending. The computation unit 116 reads information on the moving speed of the supporting base 17 used for the above computation from the memory stored in the computer 91.

The activation counter 117 obtains the current position of the supporting base 17 from the first control unit 105, sets a residual moving amount of the supporting base 17 until the supporting base 17 approaches the activation position to which the cap 51 is to be moved, and counts down the counted values indicating the residual moving amount in accordance with the moving amount of the supporting base 17 which is obtained from the first control unit 105. When the counted value of the activation counter 117 reaches “0” (zero), the second control unit 106 causes the cap 51 to move from the retractable position HP2 to the flushing position FP by driving the second motor 62 via the motor driving circuit 95. After starting the movement of the cap 51, the second control unit 106 controls the speed of the second motor 62 in accordance with a speed profile selected in accordance with the level of the liquid stored in the cap 51.

In addition, in the embodiment, it is possible to obtain the supporting base position and the cap position by using signals from the sensors 85 and 86 for detecting the position, and the encoders 63 and 64. For this reason, even in a case where the sensors 85 and 86 cannot detect the position due to the chattering or failure thereof, it is possible to obtain the activation position by the position counters 112 and 115. In addition, even in a case where the encoders 63 and 64 cannot output an accurate signal caused by any problem such as failure of the coupling, it is possible to recognize at least the activation position by using the detection signal from the sensors 85 and 86.

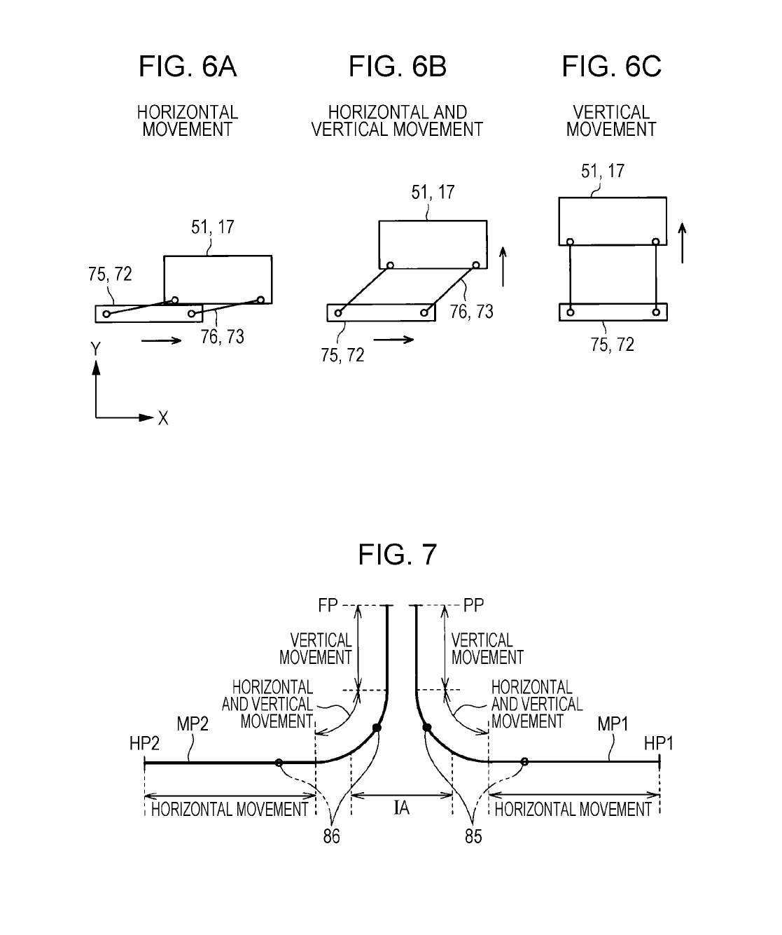

Next, motions of the supporting base 17 and the cap 51 will be described with reference to FIGS. 6A to 6C. Note that, in FIGS. 6A to 6C, a direction toward the horizontal direction from the retractable position is set to be an X direction, and a direction ascending toward the vertical direction is set to be a Y direction. The retractable positions HP1 and HP2 are set to the origin (0, 0) of an XY coordinate system.

As illustrated in FIGS. 6A to 6C, in the ascending course and the descending course, three types of motions such as the horizontal moving course, the horizontal and vertical moving course, and the vertical moving course are performed. That is, in the ascending course, the supporting base 17 and the cap 51 are moved only in the horizontal direction X in a state where the sliders 72 and 75 are forwardly moved from the retractable positions HP1 and HP2 and the inclination of the link mechanisms 73 and 76 is contestant, in the horizontal moving course as illustrated in 6A. The horizontal moving course corresponds to a course in which the pins 73A and 76A are guided to the horizontal guide portions 65a and 66a (refer to FIG. 3 and FIG. 4). The supporting base 17 and the cap 51 move from the origin (0, 0) to a coordinate (x1, 0).

Next, in the horizontal and vertical moving course illustrated FIG. 6B, the supporting base 17 and the cap 51 are moved obliquely upward while being displaced in both of the horizontal direction X and the vertical direction Y in a state where the sliders 72 and 75 are further moved forward in the X direction and the link mechanisms 73 and 76 are raised. The horizontal and vertical moving course corresponds to a course in which the pins 73A and 76A are guided to the oblique shaped guide portions 65b and 66b (refer to FIG. 3 and FIG. 4). The supporting base 17 and the cap 51 move from the coordinate (x1, 0) to the coordinate (x2, y1).

Further, in the vertical moving course illustrated in FIG. 6C, the supporting base 17 and the cap 51 ascends almost in the vertical direction Y while the sliders 72 and 75 are further moved forward in the X direction and the link mechanisms 73 and 76 are raised. The vertical moving course corresponds to a course in which the link mechanisms 73 and 76 are raised to be an almost upright state centering from the pins 73A (refer to FIGS. 3) and 76A (refer to FIG. 4) which approach terminal points of the cam holes 65 and 66. The supporting base 17 and the cap 51 move from the coordinate (x2, y1) to the coordinate (x2, y2).

On the other hand, in the descending course, as indicated by dashed arrows in FIGS. 6A to 6C, the supporting base 17 and the cap 51 are moved on a route reverse to the route of the ascending course. That is, the supporting base 17 and the cap 51 descend almost in the vertical direction in the vertical moving course as illustrated in FIG. 6C, descend obliquely downward in the horizontal and vertical moving course as illustrated in FIG. 6B, and are moved in the horizontal direction in the horizontal moving course as illustrated in FIG. 6A. The supporting base 17 and the cap 51 almost vertically descend from the coordinate (x2, y2) to the coordinate (x2, y1) in the vertical moving course, obliquely descend from the coordinate (x2, y1) to the coordinate (x1, 0) in the horizontal and vertical moving course, and are horizontally moved from the coordinate (x1, 0) to the origin (0, 0) in the horizontal moving course.

Next, the setting of the position of each of the sensors 85 and 86 for detecting the moving routes and the activation positions of the supporting base 17 and the cap 51 will be described with reference to FIG. 7. As illustrated in FIG. 7, the moving routes of the supporting base 17 and the cap 51 extend to the horizontal direction in which supporting base 17 and the cap 51 from each of the first retractable position HP1 and the second retractable position HP2 are close to each other in the horizontal moving course, extend in a state where the supporting base 17 and the cap 51 are further close to each other and are displaced in both of the horizontal direction and the vertical direction (an upward direction) in the horizontal and vertical moving course, and extend in the vertical direction in a state where the distance between the base 17 and the cap 51 is almost constant in the vertical moving course.

During the printing, in a case where the supporting base 17 is positioned at the supporting position PP, the cap 51 is positioned at the second retractable position HP2, and the flushing implement is reached, a first replacement operation including a descending operation in which the supporting base 17 is retracted from the supporting position PP to the first retractable position HP1, and an ascending operation in which the cap 51 is moved from the second retractable position HP2 to the flushing position FP is performed. In addition, at the time of the flushing, in a case where the supporting base 17 is positioned at the first retractable position HP1 and the cap 51 is positioned at the flushing position FP, and the flushing is completed, a second replacement operation including a descending operation in which the cap 51 is retracted from the flushing position FP to the second retractable position HP2, and an ascending operation in which the supporting base 17 is moved from the first retractable position HP1 to the supporting position PP.

As illustrated in FIG. 7, an interference area IA where the supporting base 17 and the cap 51 interfere with each other when being moved at the same time exist in a supporting base moving route MP1 and a cap moving route MP2. For this reason, in the embodiment, in the course of the second replacement operation, in order to prevent the supporting base 17 and the cap 51 from interfering with each other in the interference area IA, the activation timing of at least one of the supporting base 17 and the cap 51 is adjusted.

In the embodiment, the activation timing is adjusted based on the detection signal from the sensors 85 and 86. That is, at the time of performing the first replacement operation, the time when the first sensor 85 detects the fact that in the supporting base 17 and the cap 51, the supporting base 17 which is firstly activated and started to descend approaches a predetermined position is set to be the activation timing in which the cap 51 starts to be moved from the second retractable position HP2. In addition, at the time of performing the second replacement operation, the time when the second sensor 86 detects the fact that in the supporting base 17 and the cap 51, the cap 51 which is firstly activated and started to descend approaches a predetermined position is set to be the activation timing in which the supporting base 17 starts to be moved from the first retractable position HP1.

In FIG. 7, as the setting positions of the first and second sensors 85 and 86, two examples are illustrated. In the first example, the positions of the first and second sensors 85 and 86 are set at the activation timing when one of the supporting base 17 and the cap 51 is activated after the other one, which descends from the ascending position, passes through the interference area IA. In this case, each of the sensors 85 and 86 is set to be positioned (a white-circled position indicated by a two-dot chain line in FIG. 7) where each of the sensors 85 and 86 can detect the detected portion of one of the supporting base 17 and the cap 51 which descends and passes through the interference area IA. In the second example, the positions of the first and second sensors 85 and 86 are set at the activation timing when one of the supporting base 17 and the cap 51 is activated while the other one which descends from the ascending position is positioned in the interference area IA. In this case, each of the sensors 85 and 86 is set to be positioned (a black-circled position indicated by a solid line in FIG. 7) where each of the sensors 85 and 86 can detect the detected portion of one of the supporting base 17 and the cap 51, which descends from the ascending position in the interference area IA.

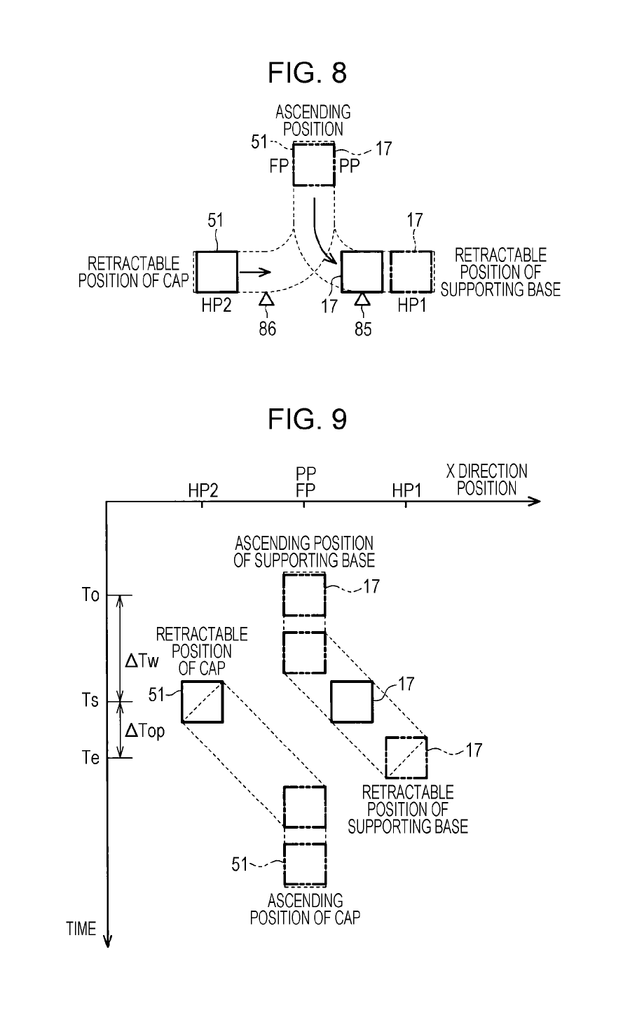

FIG. 8 illustrates the first example. As illustrated in FIG. 8, when the supporting base 17 is detected by the first sensor 85 at the activation position (indicated by a solid line in FIG. 8) where the supporting base 17 descends from the ascending position (the supporting position PP) and passes through the interference area IA, the cap 51 starts to be moved toward the ascending position from the retractable position (the second retractable position HP2) indicated by the solid line in FIG. 8.

FIG. 9 illustrates the moving timing of the supporting base 17 and the cap 51 in FIG. 8 in a coordinate system of the position in the X direction and the time. As illustrated in FIG. 9, after waiting a standby time ΔTw from a time To of starting the movement of the supporting base 17 from the ascending position (the supporting position PP) to an activation time Ts of detecting the supporting base 17 by the first sensor 85, the cap 51 starts to be moved toward the ascending position from the retractable position (the second retractable position HP2). As apparent from FIG. 9, the supporting base 17 and the cap 51 are differently positioned at the same timing, and thus the supporting base 17 and the cap 51 do not interfere with each other in the entire second replacement operation. In addition, during an overlap period ΔTop from the activation time Ts of the cap 51 to a stopping time Te of stopping the supporting base 17 when approaching the retractable position, the supporting base 17 and the cap 51 are moved at the same time. That is, the moving operation of the supporting base 17 and the moving operation of the cap 51 overlap with each in a portion of the period ΔTop. For this reason, the time required for the operation of replacing the positions of the supporting base 17 and the cap 51 with each other can be shortened by the overlap period ΔTop. In the first example, as illustrated in FIG. 9, the nearest approach distance between the supporting base 17 and the cap 51 at the same time is relatively long, and this distance can be still shortened. In the second example, the above distance is controlled to be further shortened.

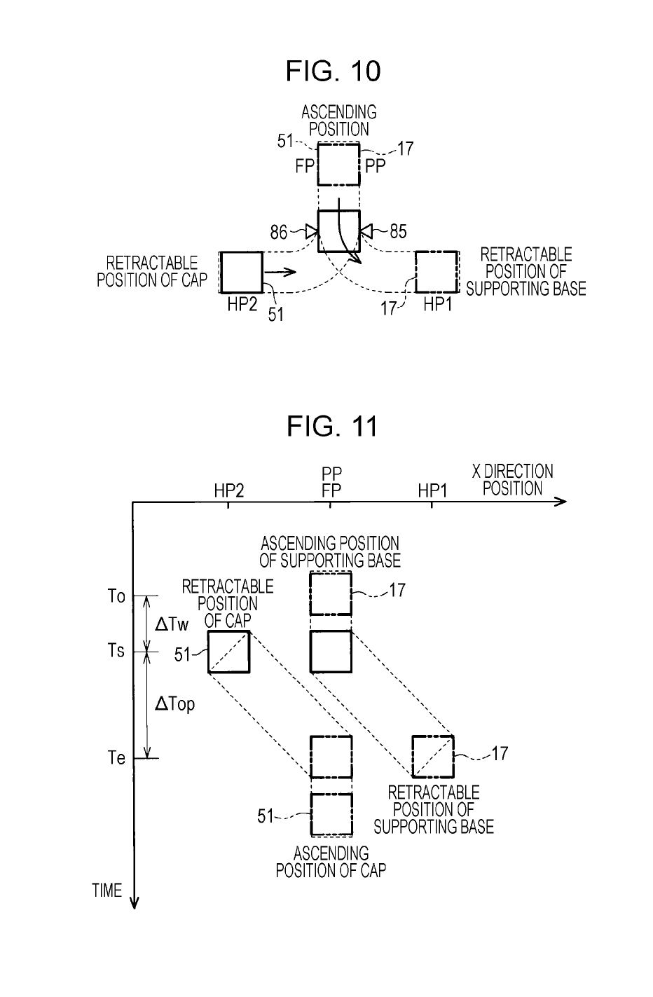

FIG. 10 illustrates the second example. As illustrated in FIG. 10, when the first sensor 85 detects that the supporting base 17 descends from the ascending position (the supporting position PP) and approaches the activation position in the interference area IA indicated by a solid line in FIG. 10, the cap 51 starts to be moved toward the ascending position from the retractable position (the second retractable position HP2) indicated by a solid line in FIG. 10.

FIG. 11 illustrates the moving timing of the supporting base 17 and the cap 51 in FIG. 10 in a coordinate system of the position in the X direction and the time. As illustrated in FIG. 11, after waiting a standby time ΔTw from a time To of starting the movement of the supporting base 17 from the ascending position (the supporting position PP) to an activation time Ts of detecting the supporting base 17 by the first sensor 85, the cap 51 starts to be moved toward the ascending position from the retractable position (the second retractable position HP2). As apparent from FIG. 11, the supporting base 17 and the cap 51 are differently positioned at the same timing, and thus the supporting base 17 and the cap 51 do not interfere with each other in the entire second replacement operation. Particularly, in this example, as illustrated in FIG. 11, the nearest approach distance between the supporting base 17 and the cap 51 at the same time set to be shorter than that in the first example, and thus the supporting base 17 and the cap 51 are considerably close to each other within the range where the supporting base 17 and the cap 51 do not interfere with each other.

In addition, during the overlap period ΔTop from the activation time Ts of the cap 51 to the stopping time Te of stopping the supporting base 17 when approaching the retractable position HP1, the supporting base 17 and the cap 51 are moved at the same time. That is, the moving operation of the supporting base 17 and the moving operation of the cap 51 overlap with each in a portion of the period ΔTop. The overlap period ΔTop is set to be longer than that in the first example. For this reason, the time required for the operation of replacing the positions of the supporting base 17 and the cap 51 with each other can be further shortened as compared with the first example by the overlap period ΔTop which becomes longer.

Meanwhile, FIG. 8 to FIG. 11 illustrate the first replacement operation in which the supporting base 17 descends from the supporting position PP and the cap 51 ascends from the second retractable position HP2 to the flushing position FP; however, also in the second replacement operation in which the cap 51 descends from the flushing position FP and the supporting base 17 ascends from the first retractable position HP1 to the supporting position PP, it is possible to shorten the time required for the replacement by the overlap period ΔTop.

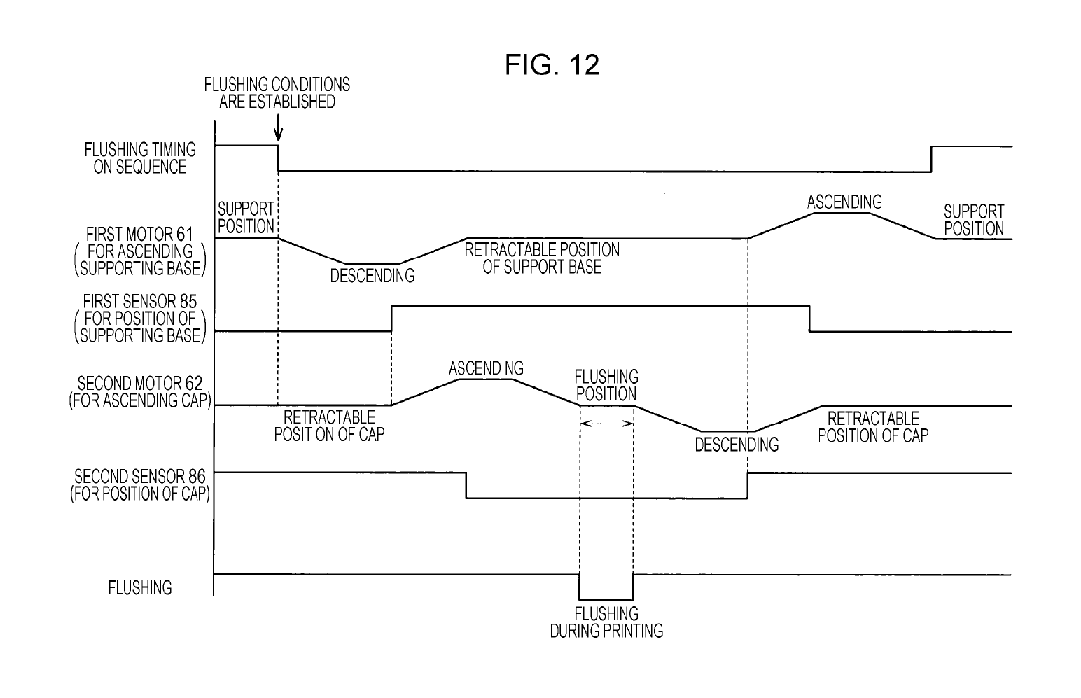

Next, a flushing operation performed during the printing will be described with reference to FIG. 12. During the printing, the supporting base 17 is disposed in the supporting position PP, and the cap 51 is disposed in the second retractable position HP2. The discharging head 18 discharge the ink droplet with respect to the sheet 14 which is transported onto the supporting base 17 which is disposed in the supporting position PP, and thus a document, an image, or the like is printed on the sheet 14.

In a case where the elapsed time from the previous flushing operation exceeds the setting time, and thus the flushing condition is established, as illustrated in FIG. 12, the start timing of the flashing is reached on the sequence. For this reason, when the flushing condition is established, the first motor 61 is reversely driven, and the supporting base 17 descends from the supporting position PP to the retractable position HP1. When the first sensor 85 which detects that the supporting base 17 approaches a predetermined position in the middle of descending is in a detection state, the second motor 62 is forwardly driven. As a result, the cap 51 ascends from the second retractable position HP2 to the flushing position FP. When the cap 51 approaches the flushing position FP, the driving of the second motor 62 is stopped. As such, the first replacement operation in which the supporting base 17 and the cap 51 are replaced to be disposed at a position at the time of the flushing is completed.

As described above, when the cap 51 is disposed in the flushing position FP, the controller 90 controls the discharging head 18 to perform the flushing during the printing. That is, the entire nozzles of the discharging head 18 discharge the ink droplets which are not related to the printing. For example, in the printing, unused nozzles which are not used for the printing exist in some cases. The ink in the unused nozzle which does not discharge ink is not exposed to the air in which the capping is not performed, and thus the ink is gradually thickened during the printing. However, the flushing is periodically performed during the printing, and the ink in the unused nozzle is re-flushed, and thus it is possible to prevent nozzle clogging caused by the thickened ink, and to reduce a frequency of the occurrence of nozzle clogging. Accordingly, it is possible to reduce printing defects caused by the nozzle clogging.

After the flushing is completed, the second motor 62 is reversely driven, and the cap 51 descends from the flushing position FP to the second retractable position HP2. When the second sensor 86 which detects that the cap 51 approaches a predetermined position in the middle of descending is in a detection state, the first motor 61 is forwardly driven. The supporting base 17 ascends from the first retractable position HP1 to the supporting position PP. As such, the second replacement operation is completed, and the supporting base 17 and the cap 51 are returned to be the original position at the time of the printing.

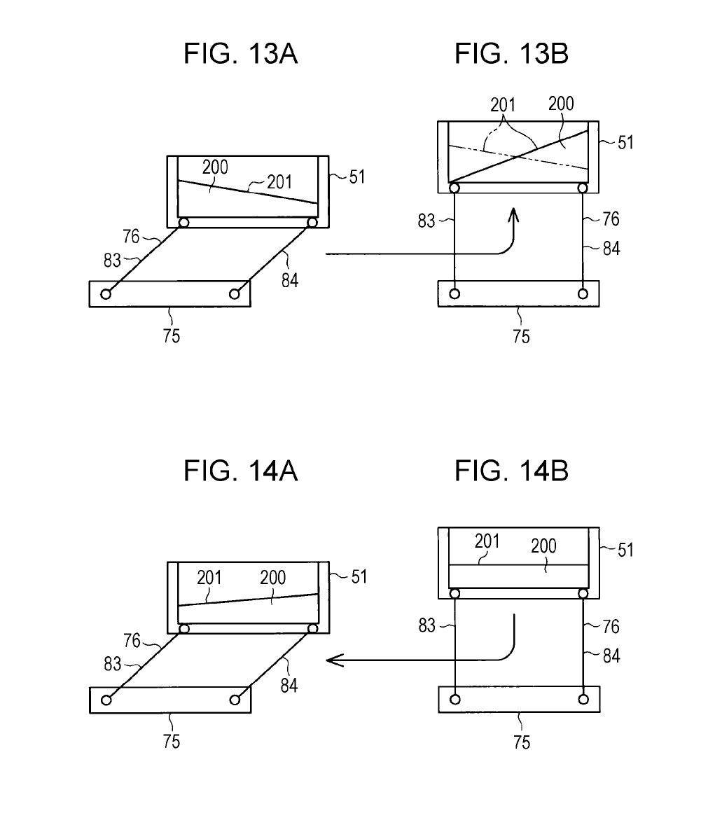

Next, the speed control of the cap 51 will be described with reference to FIG. 13A to FIG. 14B. As illustrated in FIGS. 13A and 13B, typically, ink is already stored in the cap 51 when the cap 51 is moved. In the embodiment, whenever the number of times of flushing is over a predetermined number of times, at the time of switching pages (at the time of feeding a sheet) or at the time of completing a printing job, the waste ink in the cap 51 is suctioned by driving the suction pump 88 so as to be discharged into the waste liquid tank 89. For this reason, the ink amount in the cap 51 varies depending on cases.

Meanwhile, as illustrated in FIG. 13A to FIG. 14B, in a case where the ink is stored in the cap 51, there is a concern in that the ink stored in the cap 51 may spill out in at least one of the ascending course and the descending course. In the ascending course as illustrated in FIGS. 13A and 13B, a liquid level 201 of an ink 200 is inclined such that a portion of the liquid level 201 on the side opposite to the forward direction is raised in horizontal moving course, and in the horizontal and vertical moving course illustrated in FIG. 13A, in order to make a portion of the liquid level 201 on the side (the side in the forward direction is raised) opposite to the raised side be raised in the horizontal moving course, the inclination is made small such that the liquid level 201 is made horizontal and then the liquid level 201 on the side in the forward direction is raised. In addition, in the vertical moving course illustrated in FIG. 13B, the cap 51 ascends while the liquid level 201 on the side in the forward direction is raised. Then, when the cap 51 approaches the flushing position FP and is stopped to move, the liquid 200 tends to move upward by inertia, and thus the liquid level 201 is further largely inclined as indicated by a solid line in FIG. 13B. At this time, the ink 200 stored in the cap 51 may spill out.

For this reason, in the embodiment, the moving speed of the cap 51 is changed in accordance with ink amount in the cap 51 in the ascending course of the cap 51. Specifically, as the ink amount in the cap 51 is large, the moving speed of the cap 51 is set to be relatively low in at least a portion in the moving course and the speed of the cap 51 is controlled such that the average moving speed of the cap 51 becomes slower. In the example, in the horizontal moving course in which the ink 200 is less likely to spill out, the maximum moving speed of the cap 51 is made constant without depending on the ink amount, and the maximum moving speed in the horizontal and vertical moving course and the vertical moving course is changed to be low as the ink amount is large.

On the other hand, as illustrated in FIGS. 14A and 14B, after the flushing is completed, the cap 51 descends from the ascending position(the flushing position FP) illustrated in FIG. 14B. In the ascending position, the ink 200 in the cap 51 is maintained at the constant liquid level 201. Then, in the descending course in which the cap 51 descends from the ascending position illustrated in FIG. 14B, first, the ink 200 is straightly pressed by an acceleration and a gravitational acceleration generated during the descending in the vertical moving course, then, the liquid level 201 is slightly inclined in the horizontal and vertical moving course illustrated in FIG. 14A, and the inclination of the liquid level 201 is merely increased a little in horizontal moving course. For this reason, in the descending course of the cap 51, the maximum tilt angle of the liquid level 201 is relatively small as compared with the ascending course, and the ink stored in the cap 51 is less likely to spill out. Thus, in the embodiment, in the descending course of the cap 51, the moving speed of the cap 51 is made constant without depending on the ink amount, and thus the speed of the cap 51 is controlled such that the average moving speed is made constant without depending on the ink amount.

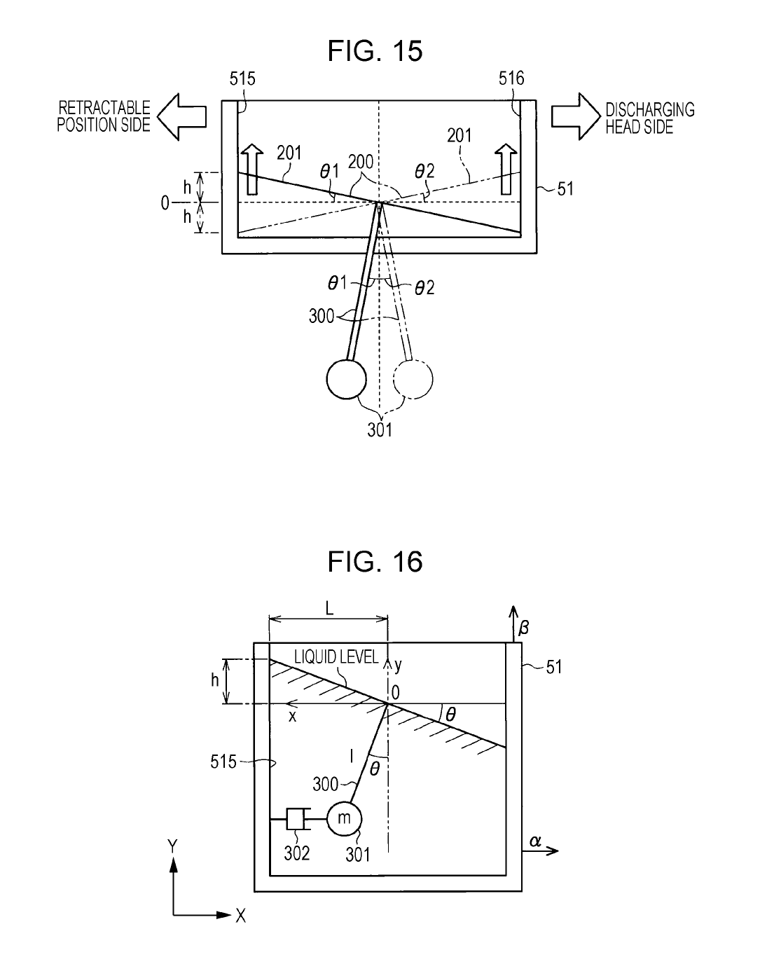

Next, a pendulum model for simulating the liquid level displacement of the liquid stored in the cap 51 will be described with reference to FIG. 15. As illustrated in FIG. 15, in the pendulum model, a motion of the liquid 200 (ink) having mass m, which is stored in the cap 51, is regarded as a motion of a pendulum 300 with a weight 301 having mass m. First, in a stopped state in which the cap 51 is stopped before the movement thereof is started, the liquid level 201 of the liquid 200 is in a horizontal state indicated by a dashed line in FIG. 15. When the cap 51 is moved to the discharging head side, the pendulum 300 of the liquid swings to the side (the retractable position side) opposite to the forward direction, and the liquid level 201 is inclined at an angle θ1 (indicated by a solid line in FIG. 15) which is equivalent to a deflection angle θ1 of the pendulum 300. In addition, when the cap 51 is moved to the retractable position side, the pendulum 300 of the liquid swings to the side opposite to the forward direction (the discharging head side), the pendulum 300 of the liquid level 201 is inclined at an angle θ2 (indicated by a two-dot chain line in FIG. 15) which is equivalent to a deflection angle θ2.

Here, the liquid level displacement in the positions of inner wall surfaces 515 and 516 of both sides of the cap 51 in the forward direction (a swing direction of the liquid) determines whether or not the liquid spills out. If the horizontal liquid level is set to be a reference value (0 (zero)), it is regarded that the value of the liquid level displacement on the inner wall surfaces 515 and 516 of both sides of the cap 51 is changed from the plus side to the minus side and vice versa without changing the absolute value thereof. Here, the inner wall surface 515 of the cap 51 on the retractable position side is set to be a liquid level displacement h. When the liquid level 201 is inclined to the direction (indicated by a solid line in FIG. 15) in a course in which the cap 51 is moved to the discharging head side, the liquid level displacement h becomes a value on the plus side, whereas when the liquid level 201 is inclined to the direction (indicated by a solid line in FIG. 15) in a course the cap 51 is moved to the retractable position side, the liquid level displacement h becomes a value on the minus side.

Next, pendulum model for simulating the liquid level displacement will be specifically described with reference to FIG. 16. As illustrated in FIG. 16, in terms of a viscous substance of the liquid in the pendulum model, the weight 301 of the pendulum 300 is connected to the inner wall surface 515 of the cap 51 via a dashpot 302. The liquid level displacement is set to be h, the deflection angle is set to be θ, a center distance of the receiving portion in the cap 51 is set to be L, an equivalent viscosity coefficient is set to be c, a liquid mass in the cap 51 is set to be m, a gravity acceleration is set to be g, an equivalent pendulum length is set to be 1, an acceleration of the cap 51 in the horizontal direction is set to be α, and an acceleration of the cap 51 in the upward vertical direction (an antigravity direction) is set to be β.

Equations of the above motions are expressed by the following Equations (1) and (2).

$$\begin{matrix}[ Equation 1 ] & \\ h = L tan θ & ( 1 ) \\ [ Equation 2 ] & \\ \ddot{θ} = - \frac{c}{m} \dot{θ} - \frac{( g - β )}{l} θ + \frac{1}{l} α & ( 2 )\end{matrix}$$

When the above Equations of the motions are solved, the liquid level displacement h is given by:

$$\begin{matrix}[ Equation 3 ] & \\ h = L tan ( \frac{1}{l} , \frac{1}{{s}^{2} + \frac{c}{m} s + \frac{( g - β )}{l}} \cdot α ) & ( 3 )\end{matrix}$$

In the above Equation (3), “s” represents a Laplace operator.

In order to prevent the liquid from spilling out from the cap 51, the liquid level displacement h is required to be small. From the above Equation (3), in order to make the liquid level displacement h small, the acceleration a in the horizontal direction and the acceleration β in the vertical direction are required to be reduced. In addition, in order to shorten the ascending time of the cap 51, a constant speed (the maximum speed) of the horizontal moving speed is set to be high, and then is set to be low at the end of the horizontal moving course so as to reduce the acceleration α in the horizontal direction before starting the horizontal and vertical moving course. The reduction of the acceleration α contributes to the reduction of the acceleration β in the vertical direction at the time of preceding the horizontal and vertical moving course.

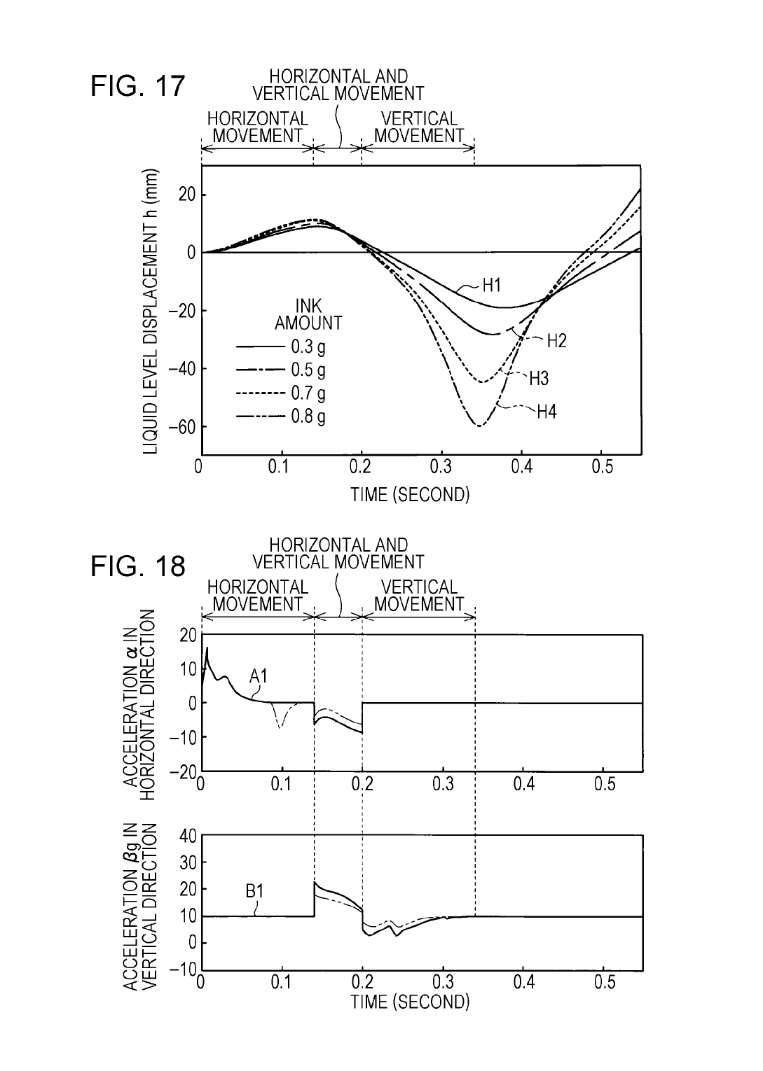

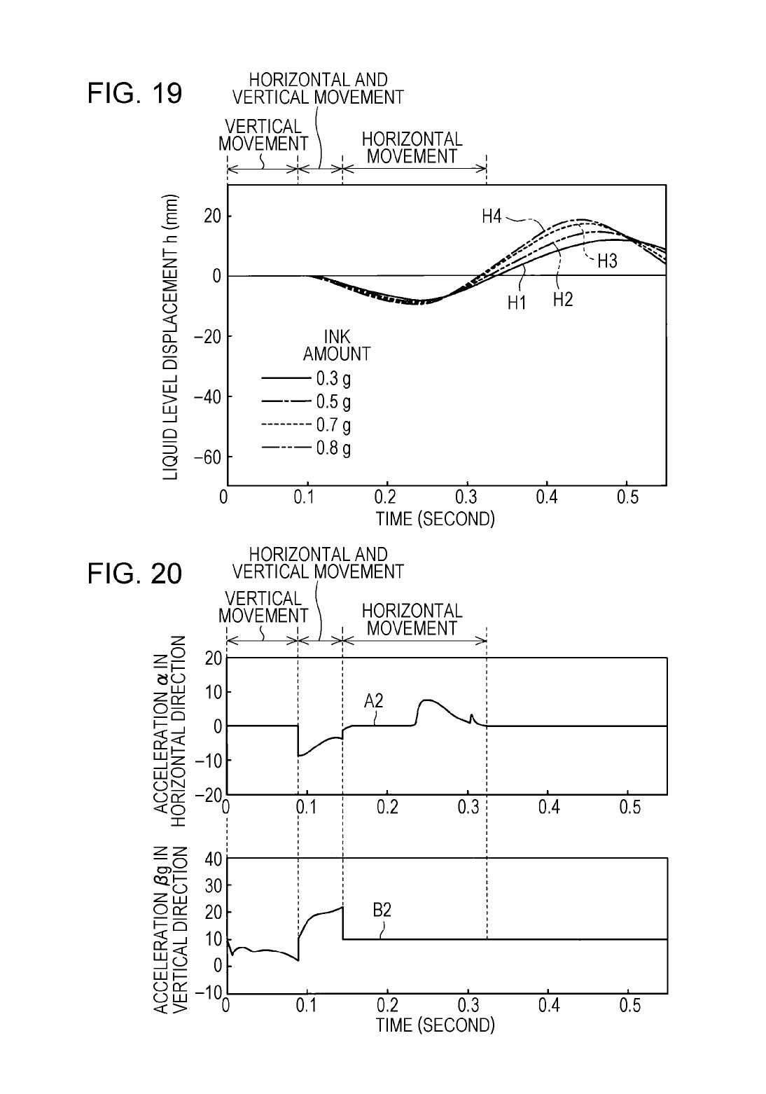

Next, a simulation result of the liquid level displacement in the pendulum model will be described with reference to FIG. 17 to FIG. 20. FIG. 17 illustrates a state of change of the liquid level displacement h in the ascending course, and FIG. 18 illustrates acceleration curves A1 and B1 which respectively indicate a state of change of the acceleration α in the horizontal direction and a state of change of the acceleration βg in the vertical direction, in the ascending course. In addition, FIG. 19 illustrates a state of change of the liquid level displacement h in the descending course, and FIG. 20 illustrates acceleration curves A2 and, B2 which respectively indicate a state of change of the acceleration α the horizontal direction and a state of change of the acceleration βg in the vertical direction, in the descending course. The acceleration a and acceleration βg in FIG. 18 and FIG. 20 are measuring values (indicated by a solid line in FIG. 18) when the cap 51 is moved at the normal constant speed (high speed V1) by driving the second motor 62, and the result of simulating the liquid level displacement h by using the measured acceleration a and acceleration βg is illustrated in the graph in each of FIG. 17 and FIG. 19. As illustrated in FIG. 17 and FIG. 19, the ink amounts (an ink mass) in the cap 51 are set to four values of 0.3 g, 0.5 g, 0.7 g, and 0.8 g. In addition, the upward vertical direction (the antigravity direction) of the acceleration βg in the vertical direction is set to be plus, and a gravity acceleration g is included in the acceleration βg, and thus the acceleration βg corresponds to a (g+β) value.

In the graphs illustrated in FIG. 17 and FIG. 19, a horizontal axis is set to be a time (second), and a vertical axis is set to be a liquid level displacement h (mm). In these graphs, regarding the liquid level displacement h in a position of the inner wall surface 515 of the cap 51 on the retractable position, the ascending displacement from the reference surface is set to be plus, and descending displacement is set to be minus based on the horizontal liquid level which is set to be a reference surface (0(zero)).

First, the liquid level displacement h in the ascending course will be described with reference to FIG. 17 and FIG. 18. As illustrated in FIG. 17 and FIG. 18, in the ascending course of the cap 51, first, when the cap 51 starts to be moved in the horizontal moving course, the plus acceleration α in the horizontal direction is applied to the liquid, and thus the liquid level displacement h ascends toward the plus side. Next, in the horizontal and vertical moving course, the acceleration α becomes minus in the horizontal direction and the acceleration βg becomes larger than the gravity acceleration in the vertical direction, and therefore, the liquid level displacement h is started to descend. Further, in the vertical moving course, the acceleration α becomes 0 (zero) in the horizontal direction and the acceleration βg becomes smaller than the gravity acceleration in the vertical direction, and the liquid level displacement h further largely descends. In addition, after the cap 51 ascends and then stopped at the flushing position FP, the liquid level displacement h further descends by inertia of the liquid, and becomes the maximum value on the minus side. Thereafter, the liquid level displacement h is turned to rise by swing back, and gradually attenuates while alternately repeating the swing to the plus side and the minus side. As described, the liquid level displacement h becomes the maximum liquid level displacement hmax immediately after the cap 51 is stopped at the flushing position FP. At this time, at the position of the inner wall surface 516 of the cap 51 on the discharging head side, the liquid level displacement becomes the maximum liquid level displacement hmax on the plus side. As apparent from the liquid level displacement curves H1 to H4 in the ascending course illustrated in the graph in FIG. 17, as the ink amount (the ink mass) is gradually increased to be 0.3 g, 0.5 g, 0.7 g, and 0.8 g, the maximum liquid level displacement hmax becomes larger.

Next, the liquid level displacement h in the descending course will be described with reference to FIG. 19 and FIG. 20. As illustrated in FIG. 19 and FIG. 20, in the descending course of the cap 51, first, in the vertical moving course, the acceleration βg which is smaller than the gravity acceleration is applied to the liquid in the vertical direction, and thus the liquid level is maintained in the horizontal state, and the liquid level displacement h is maintained to be “0 (zero)”. Next, in the horizontal and vertical moving course, the minus acceleration α is applied to the liquid, the acceleration βg which is larger than the gravity acceleration is applied to the liquid in the vertical direction, then the liquid in the cap 51 is moved to the discharging head side, and thus the liquid level displacement h. Further, in the horizontal moving course, the acceleration α becomes 0 (zero) in the horizontal direction and the acceleration βg becomes only the gravity acceleration in the vertical direction, and thus the liquid level displacement h further slightly descends by inertia of the liquid. In addition, the plus acceleration α is applied to the liquid at the retractable position HP2 in the horizontal direction immediately before the cap 51 is stopped, and the liquid level displacement h is turned to be raised. Then, after the cap 51 descends and then stopped at the retractable position HP2, the liquid level displacement h further ascends by the inertia of the liquid, and becomes the maximum value. Thereafter, the liquid level displacement h is turned to fall by swing back, and the liquid level gradually attenuates while alternately repeating the swing to the plus side and the minus side. As described, the liquid level displacement h becomes the maximum liquid level displacement hmax on the plus side immediately after the cap 51 is stopped at the retractable position HP2 in the descending course. As apparent from the liquid level displacement curves H1 to H4 in the descending course illustrated in the graph in FIG. 19, as the ink amount (the ink mass) is gradually increased to be 0.3 g, 0.5 g, 0.7 g, and 0.8 g, the maximum liquid level displacement hmax becomes larger.

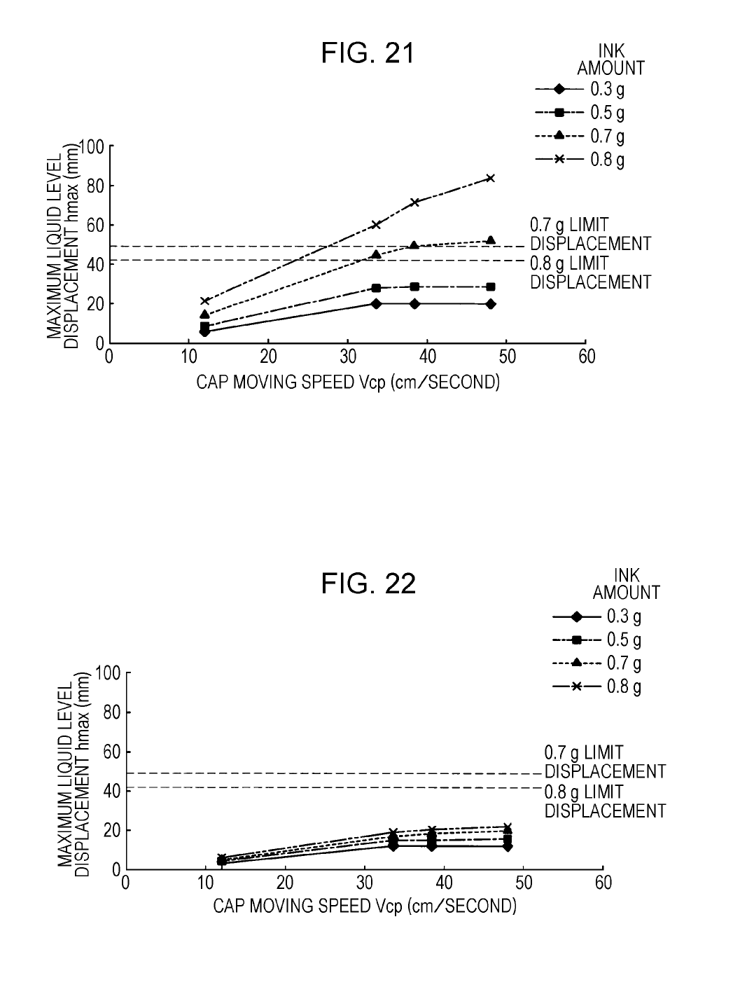

Next, a result of simulation for the maximum liquid level displacement hmax which is performed under the several conditions in which the ink amounts in the cap 51 and the different moving speeds of the cap 51 are different from each other will be described with reference to FIG. 21 and FIG. 22. The graphs in FIG. 21 and FIG. 22 illustrate a relationship between a cap moving speed Vcp (cm/second) and a maximum liquid level displacement hmax (mm) which are obtained by performing the simulation under the several conditions in which the ink amounts are different from each other. FIG. 21 is the ascending course of the cap 51, and FIG. 22 is a descending course of the cap 51. In addition, the ink amounts in the cap 51 are set to be 0.3 g, 0.5 g, 0.7 g, and 0.8 g, and the cap moving speeds Vcp are set to be 13 cm/second, 35 cm/second, 40 cm/second, and 50 cm/second in the use range thereof.

First, the maximum liquid level displacement hmax in the ascending course of the cap 51 will be described with reference to FIG. 21. As apparent from the graph illustrated in FIG. 21, the maximum liquid level displacement hmax becomes larger as the cap moving speed Vcp is high, and the ink amount of the cap 51 is large. In addition, when the ink amounts become 0.7 g and 0.8 g, and the speeds for the respective ink amounts are respectively equal to higher than 35 cm/second and equal to higher than 25 cm/second, the maximum liquid level displacement hmax for each ink amount exceeding the limit displacement (indicated by a dashed line in FIG. 21), and thus the ink spills out from the cap 51. For this reason, when the ink amount of the cap 51 is equal to or more than 0.7 g, it is necessary to suppress the cap moving speed Vcp so as not to exceed the range of the limit displacement. That is, in a case of the ink amount (which is 0.7 g or more in the example in FIG. 21) of which the maximum liquid level displacement hmax exceeds the limit displacement in the use range of the cap moving speed Vcp, it is necessary to suppress the cap moving speed Vcp such that the maximum liquid level displacement hmax does not exceed the range of the limit displacement. For this reason, in the example, in the ascending course of the cap 51, in a case where the ink amount is set to be less than 0.7 g, the cap moving speed Vcp (the maximum speed) is set to be a high speed V1 in a normal state, and in a case where the ink amount is equal to or more than 0.7 g, the cap moving speed Vcp is set to be a limit speed V2 which is lower than the high speed V1.

Next, the maximum liquid level displacement hmax in the descending course of the cap 51 will be described with reference to FIG. 22. As apparent from the graph in FIG. 22, the maximum liquid level displacement hmax in the descending course becomes larger as the cap moving speed Vcp is high and the ink amount in the cap 51 is large; however, as compared with the ascending course, the maximum liquid level displacement hmax is relatively small. For this reason, in the respective use ranges of the cap moving speed Vcp and the ink amount, the maximum liquid level displacement hmax does not exceed the limit displacement (indicated by a dashed line in FIG. 22). Accordingly, in the descending course, it is not necessary to suppress the cap moving speed Vcp to be low. For this reason, in the example, in the ascending course of the cap 51, the cap moving speed Vcp (the maximum speed) is set to be the high speed V1 in a normal state.

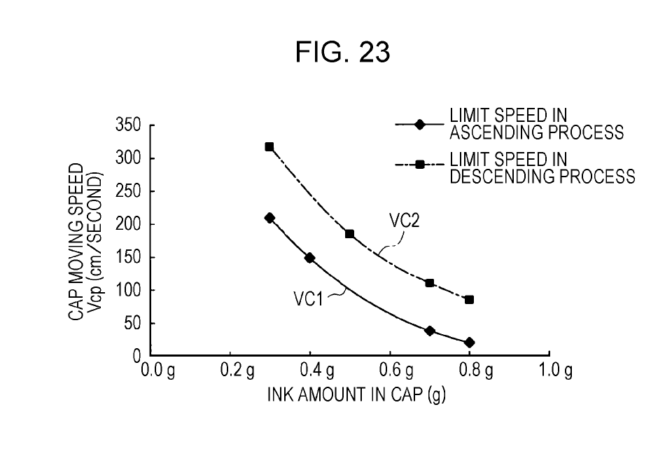

Next, a relationship between the ink amount of the cap 51 and the limit speed of the cap 51 at which the ink does not spill out from the cap 51 will be described with reference to FIG. 23. In the graph illustrated in FIG. 23, the horizontal axis represents the ink amount (g) in the cap 51, and the vertical axis represents the cap moving speed Vcp (cm/second). In the graph illustrated in FIG. 23, a solid line indicates a limit speed curve VC1 representing the limit speed Vmax in the ascending course, and a dashed line indicates a limit speed curve VC2 representing the limit speed Vmax in the descending course. As apparent from the above graph, the limit speed Vmax is reduced as the ink amount is large. In addition, if the ink amount is constant, the limit speed Vmax in the ascending course is more reduced than the limit speed Vmax in the descending course. For this reason, in the example, if the ink amount is constant, the maximum speed of the cap 51 in the ascending course is suppressed to be more reduced than the maximum speed of the cap 51 in the descending course.

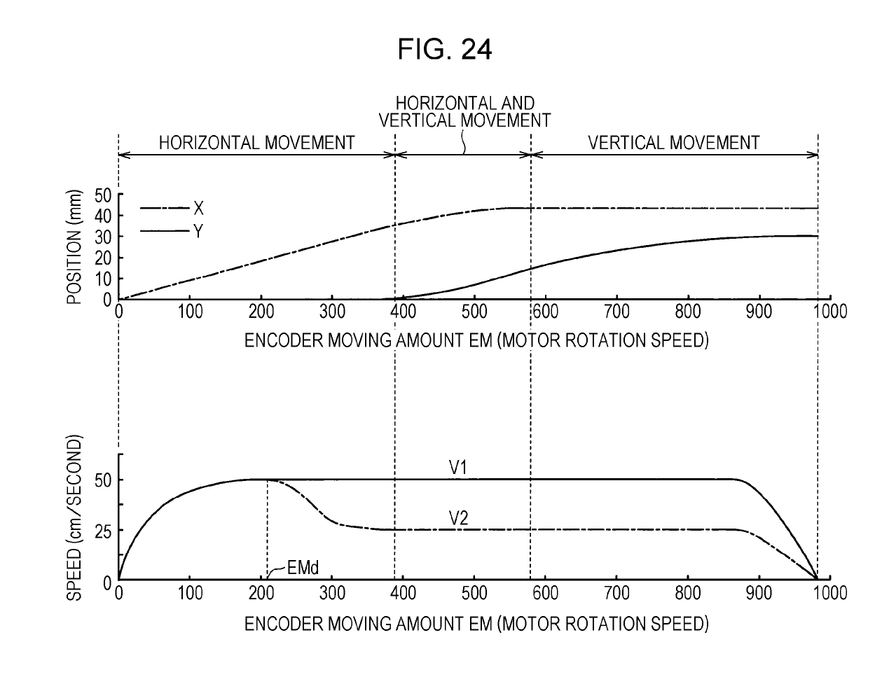

Next, a speed control of the cap 51 performed in such a manner that the computer 91 in the controller 90 suppresses the cap moving speed Vcp to be equal to or lower than the limit speed Vmax in the ascending course will be described with reference to FIG. 24. The computer 91 manages the positions of the supporting base 17 and the cap 51 with the encoder moving amount EM (a motor rotation speed) in which each of the retractable positions HP1 and HP2 is set as the origin the origin. In addition, the encoder moving amount EM in the above graph indicates the encoder moving amount EM1 for the supporting base 17, and indicates the encoder moving amount EM2 for the cap 51.

The upper graph in FIG. 24 illustrates the positions (indicated by a dashed line in FIG. 24) of the supporting base 17 and the cap 51 in the X direction (the horizontal direction) and the positions of the supporting base 17 and the cap 51 (indicated by a solid line in FIG. 24) in the Y direction (the vertical direction), with respect to the encoder moving amounts EM (EM1 and EM2). As described above, the supporting base 17 and the cap 51 are displaced from the retractable position HP (the encoder moving amount “0”) only in the X direction in horizontal moving course, are displaced in both direction of the X direction and the Y direction in the horizontal and vertical moving course, and are displaced only in the Y direction while maintaining the positions in the X direction in the vertical moving course. Note that, the area in the horizontal and vertical moving course and the vertical moving course correspond to an example of a movement area having a displacement component of the vertical direction (that is, displacement component of the vertical direction is not zero).

The lower graph in FIG. 24 illustrates the speeds of the supporting base 17 and the cap 51 with respect to the encoder moving amount EM. As indicated by a solid line, the supporting base 17 is moved in accordance with the normal speed profile in which the constant speed in a contestant speed area is set as the high speed V1, in the entire ascending course (the horizontal movement, the horizontal and vertical movement, and the vertical movement). The speed control is performed in such a manner that the computer 91 (the first control unit 105) outputs a command value in accordance with a target speed obtained by referring to data of the normal speed profile data to the motor driving circuit 94 based on the occasional encoder moving amount EM (EM1) representing the current position of the supporting base 17. As such, when controlling the speed of the supporting base 17, the date of the normal speed profile is only used.

Next, the speed control in the ascending course of the cap 51 is performed as follows. In the normal state in which the cap moving speed Vcp is not necessary to limit to be equal to or lower than the limit speed Vmax, the computer (the second control unit 106) controls the cap 51 to move in accordance with the normal speed profile in which the constant speed in a contestant speed area is set as the high speed V1, in the entire ascending course (the horizontal movement, the horizontal and vertical movement, and the vertical movement), as in the case of the speed control of the supporting base 17. That is, the speed control is performed in such a manner that the computer 91 outputs a command value in accordance with a target speed obtained by referring to data of the normal speed profile to the motor driving circuit 95 based on the occasional encoder moving amount EM (EM2) representing the current position of the cap 51.

On the other hand, when performing the speed limit control in which the condition that needs to suppress the speed of the cap 51 to be equal to or lower than the limit speed Vmax has been established, the computer 91 (the second control unit 106) controls the cap 51 to move in accordance with the speed profile for the speed limit control as indicated by a dashed line in the lower graph in FIG. 24. That is, the computer 91 controls the speed of the cap 51 to be raised to the high speed V1 in the horizontal moving course, and to be reduced to the limit speed V2 from the high speed V1, from a deceleration starting position EMd which is set during the horizontal moving course. In addition, the cap 51 is transitioned to the horizontal and vertical moving course at the limit speed V2. In the horizontal and vertical moving course, and the vertical moving course, the cap 51 is moved at a constant speed within the range of the limit speed V2, and thereafter, when the cap 51 approaches the deceleration starting position at the end of the vertical moving course, the speed of the cap 51 is reduced from the limit speed V2 so as to be stopped at the flushing position FP. The speed control of the cap 51 is performed in such a manner that the computer 91 outputs a command value in accordance with a target speed obtained by referring to data of the speed profile for limiting the speed to the motor driving circuit 95 based on the occasional encoder moving amount EM (EM2) representing the current position of the cap 51.

That is, in the movement area, which has the displacement component of the vertical direction, in the horizontal and vertical moving course, and the vertical moving course, the maximum speed when the cap 51 ascends is changed in accordance with the amount of the ink stored in the cap 51. That is, in the movement area, the maximum speed of the cap 51 in a case where the ink amount is the first ink amount (for example, less than 0.7 g) is set as the high speed V1, and the maximum speed of the cap 51 in a case where the ink amount is the second ink amount which is larger than the first ink amount (for example, equal to or larger than 0.7 g) is set as the high speed V2 which is lower than the high speed V1. In addition, the maximum speed of the cap 51 may be changed to a plurality of stages (more than three stages) in the movement area, in accordance with the ink amount, or the maximum speed of the cap 51 may be continuously changed in accordance with the ink amount in a range excluding the amount of ink which does not spill out and is less than a threshold value or in the use range of the ink amount. Even in both cases, in a case where two types of ink amounts (the first liquid level and the second liquid level) which have different maximum speeds from each other are optionally selected, the maximum speed of the cap 51 in a case where the ink amount is the second liquid level which is larger than the first liquid level is more reduced than the maximum speed of the cap 51 in a case where the ink amount is the first liquid level. Further, as apparent from the graph illustrated in FIG. 24, the average moving speed of the cap 51 in the case where the ink amount of the cap 51 is the second liquid level is more reduced than the average moving speed of the cap 51 in the case where the ink amount of the cap 51 is the first liquid level.

In addition, before the cap 51 is transitioned to the above movement area, the speed of the cap 51 is changed from the high speed V1 when the ink amount is the first ink amount to the limit speed V2 when the ink amount is the second ink amount, and then the cap 51 is transitioned to the movement area at the limit speed V2. For this reason, in the movement area, the maximum value (indicated by a two-dot chain in the graph of the lower stage in FIG. 18) of the acceleration β of the cap 51 in the vertical direction when the ink amount is the second ink amount is smaller than the maximum value (indicated by a solid line in the graph of the lower stage in FIG. 18) of the acceleration β of the cap 51 in the vertical direction when the ink amount is the first ink amount. Meanwhile, the acceleration β here means the magnitude of the acceleration (the absolute value) which excludes the gravity acceleration g in the vertical direction in the graph in FIG. 18.

Further, regarding the acceleration of the cap 51 which is obtained combining the acceleration α the horizontal direction illustrated in the graph of the upper stage in FIG. 18 and the acceleration β (the value obtained by excluding the gravity acceleration) in the vertical direction illustrated in the graph of the lower stage in FIG. 18, it can be said as follows. That is, in the movement area, the maximum acceleration (the maximum value of the combined value indicated in a two-dot chain line in the graph in FIG. 18) of the cap 51 when the ink amount is the second ink amount is more reduced than the maximum acceleration (the maximum value of the combined value indicated in a solid line in the graph in FIG. 18) of the cap 51 when ink amount is the first ink amount.

In addition, in FIG. 24, the descending course of the cap 51 is performed in such a manner that the position of the cap 51 in the upper graph follows the reverse route, and similarly, the cap 51 in the upper graph from the flushing position FP (EM=980) is accelerated to the high speed V1 and is moved at constant speed of the high speed V1, and thereafter, the speed of the cap 51 is reduced from the deceleration starting position so as to be stopped at the retractable position HP2 (EM=0). For this reason, in the above movement area, in a case where the amount of the ink (the liquid level) stored in the cap 51 is constant (for example, 0.7 g), the maximum speed when the cap 51 ascends is more reduced than the maximum speed when the cap 51 descends.

Next, an operation of the printer 11 will be described. Hereinafter, a flushing control which is performed when the flushing implementation time (an example of the maintenance implementation time) is reached during the printing will be described with reference to FIG. 25 or the like. The computer 91 executes a program which is illustrated in a flow chart in FIG. 25, for example, at least during the printing while the printer 11 is turned on.

The printer 11 starts a printing process (an example of a liquid discharging process) when receiving, for example, the printing job from a host device (not shown) such as a personal computer or a portable terminal. That is, the printer 11 transports the sheet 14 which is fed by driving the transporting motor 54 at a certain speed, controls the discharging head 18 to discharge the ink droplet from the nozzle 183 to the sheet 14 in the middle of being transported in accordance with printing data included in the printing job, and thus prints a document or an image onto the sheet 14 based on the print data.

During the printing, as illustrated in FIG. 3, the supporting base 17 is disposed in a supporting position PP which faces the discharging head 18 with a predetermined gap therebetween, and supports the sheet 14 in the middle of being transported. In addition, during the printing, the cap 51 retracted to the second retractable position HP2.

Hereinafter, a flushing control routine which is performed by the computer 91 will be with reference to FIG. 25 or the like.

First, in step S11, it is determined that whether or not the flushing implementation time is reached. During the printing, the main control unit 101 controls the timer 111 to count an elapsed time from the time of the previous flushing operation, and when the counting time reaches the setting time and thus the flushing condition is established, it is determined that the flushing implementation time is reached. If the flushing implementation time is determined, the process proceeds to step S12, and if not, the process is standby until the flushing implementation time is reached. In addition, when the flushing implementation time is reached, the discharging head 18 stops discharging ink.

In step S12, first, the supporting base 17 is moved from the supporting position PP to the first retractable position HP1 by driving the first motor 61. That is, the first control unit 105 selects the normal speed profile, and controls the speed of the first motor 61 by commanding the target speed in response to the encoder moving amount EM1 which is counted by the position counter 112, in accordance with the selected normal speed profile. As a result, the first motor 61 is reversely driven at a certain speed, and the supporting base 17 descends at almost the high speed V1 from the supporting position PP.

Next, in step S13, the ink amount in the cap is obtained. That is, the ink amount is obtained based on the counted value obtained by counting the number of times of flushing the liquid in the liquid measuring unit 103.

In step S14, a speed mode is determined in accordance with to the ink amount. That is, the second control unit 106 determines a normal speed mode or a limit speed mode in accordance with to the ink amount, and selects speed control data (the speed profile data) corresponding to the determined speed mode. When the ink amount is less than 0.7 g, for example, 0.3 g or 0.5 g, the second control unit 106 selects the normal speed profile data, and when the ink amount is equal to or greater than 0.7 g, for example, 0.7 g or 0.8 g, the second control unit 106 selects the speed profile data for limiting the maximum speed to equal to or lower than the limit speed V2.

In step S15, it is determined whether or not the first sensor is turned on. In other words, it is determined whether or not the first sensor 85 is turned on after the supporting base 17 which firstly starts to be moved from the supporting position PP approaches the first position (a cap activation position). If it is determined whether or not the first sensor 85 is turned on, the process proceeds to step S16, and if the first sensor 85 is not turned on, the process is standby until the first sensor 85 is turned on.

In step S16, the cap 51 is moved from the second retractable position HP2 to the flushing position FP by driving the second motor 62. That is, the second control unit 106 controls the second motor 62 to be forwardly driven, and controls the speed of the second motor 62 by commanding the target speed in response to the encoder moving amount EM2 which is counted by the position counter 115, in accordance with the previously selected speed profile. Here, as illustrated in FIG. 7, when the supporting base 17 which is started to descend from the supporting position PP approaches the first position (the cap activation position) indicated by a solid line or a lead line of the two-dot chain line in FIG. 7, and thus the first sensor 85 is turned on, the cap 51 starts to be moved from the second retractable position HP2. For this reason, the ascending cap 51 does not interfere with the descending supporting base 17 in the interference area IA. That is, the supporting base 17 which firstly starts to be moved from the supporting position PP passes through the interference area IA in the retracting direction, and then the cap 51 which starts to be moved before the supporting base 17 approaches the retractable position HP1 passes through the interference area IA in the direction close to the discharging head 18.

At this time, even in a case where the sensors 85 and 86 are at the positions in FIG. 8 or FIG. 10, as illustrated in FIG. 9 and FIG. 11, the supporting base 17 starts to be moved from the ascending position (the supporting position PP), then the cap 51 is started late to move from the retractable position by standby time ΔTw, and thus the moving operation of the supporting base 17 and the moving operation of the cap 51 overlap with each other only during an overlap period ΔTop. Note that, in the embodiment, the processes in steps S11 to S16 corresponding to an example of a “first moving step”.

In step S17, it is determined whether or not the cap 51 approaches the flushing position. If the cap 51 approaches the flushing position FP, the process proceeds to step S18, and if the cap 51 does not approach the flushing position FP, the process is standby until the cap 51 approaches the flushing position FP.

In step S18, the flushing is performed. That is, the head control unit 102 controls the discharging head 18 to discharge the ink droplets which are not related to the printing from the nozzle 183 into the cap 51 disposed in the flushing position FP. As a result, the thickened ink in the nozzle 183 is discharged, and thus it is possible to prevent or eliminate the ink clogging of the nozzle 183. Note that, in the embodiment, the process in step S18 corresponds to an example of a “maintenance step”.

Next, in step S19, a count process of the ink amount is performed. That is, the liquid measuring unit 103 adds the counted value of one flushing operation to the counted value of the liquid level counter. In this way, the liquid level counter obtains the counted value indicating the current liquid level (the ink amount) in the cap 51.

In step S20, the cap 51 is moved from the flushing position FP to the second retractable position HP2 by driving the second motor 62. That is, the second control unit 106 controls the speed of the first motor 61 by commanding the target speed in response to the encoder moving amount EM2 which is counted by the position counter 115, in accordance with the previously selected speed profile. As a result, the second motor 62 is reversely driven at a certain speed, and the cap 51 descends at almost the high speed V1 from the flushing position FP.

Next, in step S21, it is determined whether or not the second sensor is turned on. That is, it is determined whether or not the second sensor 86 is turned on after the cap 51 firstly starts to be moved from the flushing position FP approaches the second position (a supporting base activation position). If it is determined that the second sensor 86 is turned on, the process proceeds to step S22, and if the second sensor 86 is not turned on, the process is standby until the second sensor 86 is turned on.

In step S22, the supporting base 17 is moved from the first retractable position HP1 to the supporting position PP by driving the first motor 61. That is, the first control unit 105 controls the first motor 61 to be forwardly driven, and controls the speed of the first motor 61 by commanding the target speed in response to the encoder moving amount EM1 which is counted by the position counter 112. Note that, in the embodiment, the processes in steps S20 to S22 corresponds to a “second moving step”.

Here, as illustrated in FIG. 7, the cap 51 which is started to descend from the flushing position FP approaches the second position (the supporting base activation position) indicated by a solid line or a lead line of the two-dot chain line in FIG. 7, and thus the second sensor 86 is turned on, the supporting base 17 starts to be moved from the first retractable position HP1. For this reason, the ascending supporting base 17 does not interfere with the descending cap 51 in the interference area IA. In other words, the cap 51 which firstly starts to be moved from the flushing position FP passes through the interference area IA in the retracting direction, and then supporting base 17 which starts to be moved before the cap 51 approaches the retractable position HP2 passes through the interference area IA in the direction close to the discharging head 18. At this time, even in a case where the sensors 85 and 86 are at the positions in FIG. 8 or FIG. 10, the replacement of the supporting base 17 and the cap 51 is merely reversed as compared with the examples illustrated in FIG. 8 to FIG. 11. For this reason, the cap 51 starts to be moved from the ascending position (the flushing position FP), then the supporting base 17 is started late to move from the retractable position HP1 by standby time ΔTw, and thus the moving time of the supporting base 17 and the moving time of the cap 51 overlap with each other only during an overlap period ΔTop. In this way, if the flushing is finished during the printing, the printing which has been temporarily suspended due to the flushing is resumed.

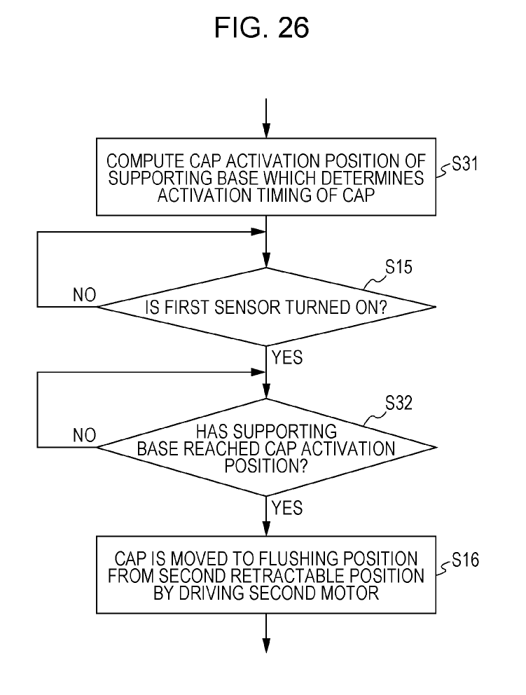

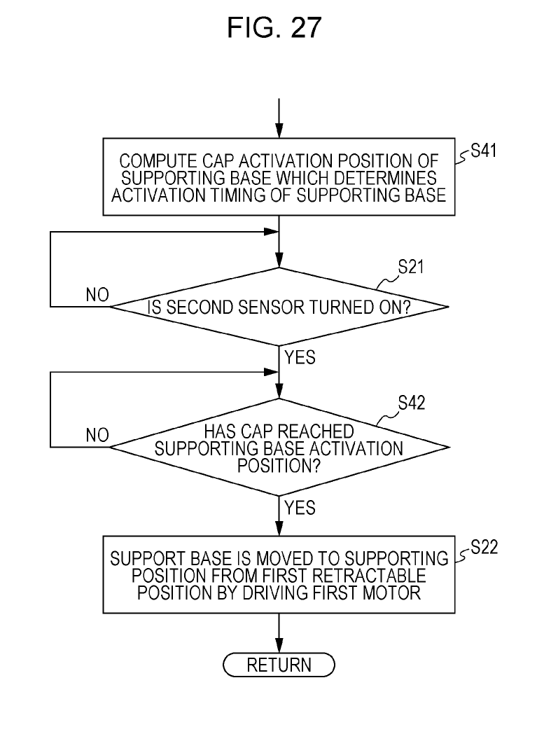

Next, a second method of determining the activation timing of the supporting base 17 and the cap 51 will be described. in a case where the first position (the cap activation position) of the supporting base 17 determining the activation timing of the cap 51 is computed, the computer 91 controls the following operations in accordance with the flow charts illustrated in FIG. 26 and FIG. 27. In addition, only the processes of determining the activation timing of the supporting base 17 and the cap 51 are different from each other, and thus only a portion of the process which is different from an example in FIG. 25 will be described in FIG. 26 and FIG. 27. In addition, in the example, the first sensor 85 and the second sensor 86 are set to be at the position on the ascending position side further than the assuming activation position by at least an expecting time required for the computation. Meanwhile, it is possible to remove the sensors 85 and 86.

After the processes in steps S11 to S14 in FIG. 25, and the supporting base 17 is stated to move (retract) from the supporting position PP, first, the cap activation position of the supporting base 17 which determines the activation timing of the cap 51 is computed in step S31 in illustrated in FIG. 26. The computation unit 116 of the computer 91 computes a required time T1 (=(EMout−EMs)/V1) during which the supporting base 17 is moved from a detecting position EMs to an exit position EMout on the basis of the detecting position EMs in which the first sensor 85 detects the supporting base 17, the exit position EMout in which the supporting base 17 completely passes though the interference area IA, and the moving speed V1 of the supporting base 17. In addition, the computation unit 116 computes a required time T2 (=EMin/Vcp) during which the cap 51, which starts to be moved from the retractable position HP2 at the cap moving speed Vcp determined based on the ink amount at the time of moving, approaches an entrance position EMin in the interference area IA. In addition, a distance d (=V1·(T1−T2)) of a converted value of the encoder moving amount is computed by using both required times T1 and T2 and the moving speed V1 of the supporting base 17, and a cap activation position EMstrt (=EMout−d) is computed as a position on the ascending position (the supporting position PP) side from the exit position EMout by the distance d. In addition, a moving amount (distance) from the detecting position Ems to the cap activation position EMstrt is computed as a remaining moving amount ΔREM (=EMstrt−EMs), and the counted value corresponding to the remaining moving amount ΔREM is set in the activation counter 117. Meanwhile, the exit position EMout and the entrance position EMin are on the most ascending position side in which the supporting base 17 and the cap 51 do not interfere with each other even when being positioned on the exit position EMout and the entrance position EMin.

Next, in step S15, it is determined whether or not the first sensor is turned on. If the first sensor 85 is turned on by detecting the supporting base 17 which approaches the detecting position, the activation counter 117 starts a counting operation (countdown). As a result, in the following description, the counted value of the activation counter 117 is reduced by subtracting a value corresponding to the moving amount in accordance with the movement of the supporting base 17.

Next, in step S32, it is determined whether or not the supporting base 17 approaches the cap activation position. The second control unit 106 determines whether or not the supporting base 17 approaches the cap activation position based on the determination whether or not the counted value (the remaining moving amount) of the activation counter 117 becomes 0 (zero). If the supporting base 17 has not approached the cap activation position, the process is standby until the supporting base 17 approaches the cap activation position. On the other hand, if the supporting base 17 approaches the cap activation position, the process proceeds to step S16.

In addition, in step S16, the cap 51 is moved from the second retractable position HP2 to the flushing position FP by driving the second motor 62. As a result, when the descending supporting base 17 which firstly passes through the interference area IA exits from the exit position EMout in the interference area IA, the ascending cap 51 enters the interference area IA from the entrance position EMin, and thus the descending supporting base 17 and the cap 51 do not interfere with each other. Note that, in the embodiment, the processes in steps S31, S15, S32, and S16 correspond to an example of the “first moving step”.

Next, when the cap 51 after being flushed and the positions of the supporting base 17 in the retracted state are replaced with each other, the computer 91 activates the supporting base 17 by controlling the following operations illustrated in a flow chart in FIG. 27.

After the processes in steps S17 to S20 in FIG. 25 are completed, and the cap 51 starts to be moved (retracted) from the flushing position FP, first, a supporting base activation position of the cap 51 which determines the activation timing of the supporting base 17 is computed in step S41 illustrated in FIG. 27. The computation unit 113 of the computer 91 obtains the detecting position EMs in which the second sensor 86 detects the cap 51, the exit position EMout in which the cap 51 completely passes though the interference area IA, and the moving speed Vcp (for example, Vcp=V1) of the cap 51 from a memory. In addition, the computation unit 113 computes a required time T1 (=(EMout−EMs)/Vcp) during which the cap 51 is moved from a detecting position EMs to an exit position EMout on the basis of the detecting position EMs, the exit position EMout, and the moving speed Vcp. In addition, the computation unit 113 computes a required time T2 (=EMin/V1) during which the supporting base 17 which starts to be moved from the retractable position HP1 to the moving speed V1 approaches the entrance position EMin of the interference area IA. In addition, the distance d (=Vcp·(T1−T2)) is computed by using both required times T1 and T2, and the cap moving speed Vcp, and the supporting base activation position EMstrt (=EMout−d) is computed as a position as a position on the ascending position (the flushing position FP) side from the exit position EMout to the distance d. In addition, a moving amount (distance) from the detecting position EMs to the supporting base activation position EMstrt is computed as a remaining moving amount ΔREM (=EMstrt−EMs), and the counted value corresponding to the remaining moving amount ΔREM is set in the activation counter 114. Meanwhile, the exit position EMout and the entrance position EMin are on the most ascending position side in which the cap 51 and the supporting base 17 do not interfere with each other even when being positioned on the exit position EMout and the entrance position EMin.

Next, in step S21, it is determined whether or not the second sensor is turned on. If the second sensor 86 is turned on by detecting the cap 51 which approaches the detecting position, the activation counter 114 starts a counting operation (countdown). As a result, in the following description, the counted value of the activation counter 114 is reduced by subtracting a value corresponding to the moving amount in accordance with the movement of the cap 51.

Next, in step S42, it is determined whether or not the cap 51 approaches the cap activation position. The first control unit 105 determines whether or not the cap 51 approaches the supporting base activation position based on the determination whether or not the counted value (the remaining moving amount) of the activation counter 114 becomes 0 (zero). If the cap 51 has not approached the supporting base activation position, the process is standby until the cap 51 approaches the supporting base activation position. On the other hand, if the cap 51 approaches the supporting base activation position, the process proceeds to step S22.

In addition, in step S22, the supporting base 17 is moved from the first retractable position HP1 to the supporting position PP by driving the first motor. As a result, when the descending cap 51 which firstly passes through the interference area IA exits from the exit position EMout in the interference area IA, the ascending supporting base 17 enters the interference area IA from the entrance position EMin, and thus the descending supporting base 17 and the cap 51 do not interfere with each other. Note that, in the embodiment, the processes in steps S41, S21, S42, and S22 correspond to an example of the “second moving step”.

In addition, in the above example, a subtraction starting position is set when the first sensor 85 and the second sensor 86 are turned on the remaining moving amount; however, the sensors 85 and 86 may be removed and the it may be determined whether or not the supporting base 17 or the cap 51 approaches the subtraction starting position based on the counted value of the position counter. The timing of computing the activation position is after the flushing implementation time, and is before at least the time when the supporting base 17 or the cap 51 approaches the assuming activation position by the time required for the computation, in which the time required for the computation can be properly changed as long as the computation is completed during when the supporting base 17 and the cap 51 approaches the activation position.

According to the first embodiment described above, it is possible to achieve the effect described below.

(1) The supporting base 17 and the cap 51 (an example of the maintenance unit) are replaced with each other by the different power of each of the first motor 61 and the second motor 62 which are controlled by the controller 90. For this reason, it is possible to separately control the supporting base 17 and the cap 51 from each other, but in this case, there is a concern in that the supporting base 17 and the cap 51 may interfere with each other in the interference area IA in which the moving routes thereof are close to each other at the position in the vicinity of the ascending position PP, FP. The controller 90 controls the respective motors 61 and 62 such that the supporting base 17 and the cap 51 are moved one by one in the interference area IA, and thus the moving operation of the supporting base 17 and the moving operation of the cap 51 overlap with each other in at least a portion. Accordingly, it is possible to replace the supporting base 17 and the cap 51 which have different the power sources at a relatively high speed while preventing the supporting base 17 and the cap 51 from interfering with each other. Thus, in the flushing implementation time during the printing, the flushing in which the ink droplet from the discharging head 18 is discharged to the cap 51 which is disposed at the flushing position FP after rapidly replacing the positions of the supporting base 17 and the cap 51 with each other, and then the supporting base 17 and the cap 51 are rapidly returned to the original positions at the time of the printing such that the next printing can be rapidly started. For this reason, it is possible to obtain a high printing throughput for the operation of replacing the positions of the supporting base 17 and the cap 51 with each other at the time of the flushing.

(2) When the positions of the supporting base 17 and the cap 51 are replaced with each other, each of the motors 61 and 62 are controlled such that one of the supporting base 17 and the cap 51 which is retracted from the ascending position PP, FP firstly passes through the interference area IA in the retracting direction, and then, before the one is completely retracted, the other one which starts to be moved toward the ascending position PP, FP passes through the interference area IA in the direction close to the discharging head 18. Accordingly, it is possible to replace the positions of the supporting base 17 and the cap 51, which have different power sources from each other, with each other at a relatively high speed while preventing the supporting base 17 and the cap 51 from interfering with each other.

(3) The first sensor 85 and the second sensor 86 are provided as an example of the detecting unit which detects the supporting base 17 and the cap 51 at the activation position on each of the moving routes thereof. In addition, when the positions of the supporting base 17 and the cap 51 are replaced with each other, one of the supporting base 17 and the cap 51 which is retracted from the ascending position PP, FP is firstly moved, and when the sensors 85 and 86 (an example of the detecting unit) detect that the one approaches the activation position in the middle of moving from the ascending position PP, FP, the other one starts to be moved from the retractable position to the ascending position PP, FP. Therefore, it is possible to replace the positions of the supporting base 17 and the cap 51, which have different power sources form each other, with each other at a relatively high speed while preventing the supporting base 17 and the cap 51 from interfering with each other. Since it is not necessary to particularly adjust a speed so as to prevent the supporting base 17 and the cap 51 from interfering with each other, and the supporting base 17 and the cap 51 are moved by driving the motors 61 and 62 at a certain speed without changing the speed, and therefore, the motor control is easily performed by the controller 90.

(4) Regarding at least the cap 51 in the supporting base 17 and the cap 51, the speed can be changed. In addition, the controller 90 changes the activation timing in accordance with the speed of the cap 51 when the supporting base 17 is moved from the retractable position HP1 to the ascending position PP. Accordingly, when the positions of the supporting base 17 and the cap 51, which have the different power sources from each other, are replaced with each other, even in a case where the speed of at least one of the supporting base 17 and the cap 51 is changed, it is possible to relatively reliably prevent the supporting base 17 and the cap 51 from interfering with each other, and suppress the time required for the replacement to be relatively short.

(5) The interference area IA in which the supporting base 17 and the cap 51 are interfere with each other exists in a portion of each of the moving routes of the supporting base 17 and the cap 51. When one of the supporting base 17 and the cap 51 is in the interference area IA, the controller 90 controls the other one to start to be moved. Thus, the time required for replacing the positions of the supporting base 17 and the cap 51 with each other can be further shortened.

(6) At the flushing position FP facing the discharging head 18, the cap 51 performs the flushing (the idle discharge) as the maintenance of the discharging head 18 by receiving the ink discharged from the discharging head 18 in the cap portion 53. Therefore, the replacement of the supporting base 17 and the cap 51 is performed at a relatively high speed, and thus it is possible to complete the maintenance, which is performed by receiving the ink discharged from the discharging head 18 in the cap portion 53, at a relatively high speed. For example, in a case where the maintenance such as the flushing is performed by interrupting the ink discharge onto the medium such as the sheet 14, it is possible to efficiently perform the printing process (an example of the liquid discharging process) with respect to the sheet 14 by rapidly completing the maintenance.

(7) The moving route of the cap 51 includes the movement area (the horizontal and vertical movement area and the vertical movement area) having the displacement component of the vertical direction, and the cap 51 includes the cap portion 53 in which the ink discharged from the discharging head 18 is stored. The controller 90 changes at least the speed in the movement area of the cap 51 which has the displacement component of the cap 51 in the vertical direction in accordance with the amount of the ink stored in the cap 51. Thus, the ink in the cap 51 is less likely to spill out in the horizontal and vertical moving course and the vertical moving course.

(8) The moving route of the maintenance unit includes the first movement area which does not have the displacement component in the vertical direction, and the second movement area having the displacement component in the vertical direction. The controller 90 further reduces the maximum speed of the course in which the cap 51 is moved in the horizontal and vertical movement area and the vertical movement area (an example of the second movement area) when the amount of the ink stored in the cap 51 is the second liquid level which is higher than the first liquid level, as compared with the case where the amount of the ink stored in the cap 51 is the first liquid level. Accordingly, in the course in which the cap 51 is moved in the second movement area, it is easy to prevent the cap portion 53 of the cap 51 from spilling out.

(9) The maximum acceleration of the course in which the second movement area is moved becomes further reduced when the amount of the ink stored in the cap 51 is the second liquid level which is higher than the first liquid level, as compared with the case where the amount of the ink stored in the cap 51 is the first liquid level. Accordingly, in the course in which the cap 51 is moved in the horizontal and vertical movement area and the vertical movement area (an example of the second movement area), the ink stored in the cap 51 is less likely to spill out.

(10) The controller 90 further reduces at least the maximum acceleration having the displacement component of the vertical direction in the course of moving the horizontal and vertical movement area and the vertical movement area (an example of the second movement area) in the ascending course of the cap 51 when the amount of the ink stored in the cap 51 is the second liquid level which is higher than the first liquid level, as compared with the case where the amount of the ink stored in the cap 51 is the first liquid level. Accordingly, the ink in the cap 51 is less likely to spill out in the ascending course of the cap 51.

(11) At least a portion of the moving route is displaced in the vertical direction by the moving mechanism, and in a case where the liquid level stored in the cap 51 is contestant, the controller 90 further reduces the maximum speed in the ascending course of the cap 51 in the vertical direction than the maximum speed in the descending course of the cap 51 in the vertical direction. Accordingly, in a case where the amount of the ink stored in the cap 51 is constant, even in the case of the ascending course of the cap 51, it is possible to make the liquid barely spill out as in a descending course.

(12) The controller 90 further reduces the average moving speed of the cap 51 in a case where the ink amount of the cap 51 is the second liquid level which is higher than the first liquid level as compared with the case where the ink amount of the cap 51 is the first liquid level. Accordingly, even in the case where the ink amount of the cap 51 is the second liquid level, it is possible to make the liquid stored in the cap 51 barely spill out in the course of moving the cap 51 as in the case where the ink amount of the cap 51 is the first liquid level.

(13) The controller 90 counts the number of times of liquid discharge which is performed by the discharging head 18 with respect to the cap 51, and the ink amount of the cap 51 is obtained from the number of times of the liquid discharge. Accordingly, it is possible to relatively easily obtain the ink amount of the cap 51 from the number of times of liquid discharge which is performed by the discharging head 18 with respect to the cap 51.

Note that, the above embodiment may be modified in the following forms.

In the above embodiment, the supporting base 17 and the cap 51 overlap with each other in a portion in each of the moving operations; however, the supporting base 17 and the cap 51 may overlap with each other during the entire period in the moving operations as long as it is possible to prevent the supporting base and the cap from interfering with each other in the interference area. For example, the supporting base 17 and the cap 51 start to be moved at the same time, are moved one by one in the interference area in the middle of moving, and are stopped at the same time at each position where the replacement is completed.

In the above embodiment, the maintenance unit may be moved from the retractable position to a predetermined position in a state where constantly being empty by performing a suctioning operation of discharging the liquid whenever the cap 51 is retracted. According to this configuration, it is not necessary to particularly adjust the speed in accordance with the level of the liquid stored in the maintenance unit, and thus it is easy to control, and it is possible to greatly shorten the time required for the replacement. If the liquid level in the maintenance unit is equal to or greater than the threshold (for example, 0.7 g), the receiving portion of the maintenance unit may be in an empty state by performing the suctioning operation at the retractable position.

In the above embodiment, the moving speed and the acceleration of the cap 51 are changed in accordance with the amount of the ink stored in the cap 51; however, a configuration in which the speed and the acceleration are not changed without depending on the amount of the ink stored in the cap 51 may be employed. For example, even with the assuming maximum liquid level, the maintenance unit may be constantly moved at the speed and the acceleration at which the ink does not spill out.

The detecting unit may be at least one of the sensor and the encoder. In the above embodiment, a configuration in which the encoder is removed, and the detecting unit is set as only the sensors 85 and 86, or the sensors 85 and 86 are removed and the detecting unit is set as only the encoder may be employed. One of the supporting base and the maintenance unit may be detected by the sensor, and the other one may be detected by the encoder. In addition, both of the supporting base and the maintenance unit may be detected by the encoder.

The detecting unit may detect at least one of the supporting base and the maintenance unit at a position in the interference area in the course of retracting from a predetermined position. Particularly, it is preferable that the detection is performed at the position in the interference area in the course in which both of the supporting base and the maintenance unit are retracted from the predetermined position. That is, the detecting unit is provided at the position in which the supporting base and the maintenance unit can be detected in the interference area. According to the configuration, it is possible to suppress the time required to replace the positions of the supporting base and the maintenance unit with each other to be relatively shortened.

Also, in the descending course of the cap 51, the moving speed of the cap 51 may be changed in accordance with the level of the liquid (the ink amount) in the cap 51. For example, as the level of the liquid (the ink amount) in the cap 51 is large, the moving speed of the cap 51 becomes reduced.

Also, in the ascending course of the cap 51, the control of changing the cap moving speed in accordance with the ink amount may be removed by setting the cap moving speed to be a certain speed in the range of the speed at which the ink does not spill out without depending on the ink amount.

In at least one of the moving routes of the supporting base 17 and the cap 51, the horizontal movement area may be removed. For example, a configuration of only the horizontal and vertical area and the vertical movement area may be employed, or a configuration of only the horizontal and vertical movement area may be employed. In addition, a moving course in which the movement is started from the retractable position and is displaced in the vertical direction may exist, and then a horizontal moving course may exist immediately before approaching the ascending position. In short, the moving route including at least one area among an area in which the moving object is displaced only in the horizontal direction, an area in which the moving object is displaced in both of the horizontal direction and the vertical direction, and an area in which the moving object is displaced in only the vertical direction may be employed, and in this case, any number of each area may exist at any position on the moving route in any order. For example, it may be a moving route formed of an area of moving in the horizontal direction. In addition, the moving routes of the supporting unit and the maintenance unit may have different lengths and shapes from each other. Further, a predetermined position in which the supporting unit and the maintenance unit are disposed faces the nozzle opening surface of the discharging head; however, the predetermined position is set to be a descending position, and the supporting unit and the maintenance unit may be moved between the retractable position and the descending position. In addition, one of the supporting unit and the maintenance unit is disposed at a predetermined position which is the ascending position, and the other one is disposed at a predetermined position which is the descending position. In this way, the moving course in which the moving object is directed to from the retractable position to the predetermined position can be optionally selected from the ascending course, the descending course, and the horizontal moving course, and a combination in the moving courses of the supporting unit and the maintenance unit can be optionally selected.

When the positions of the supporting base 17 and the cap 51 are replaced with each other, both may start to be moved at the same time. In this way, even when both start to be moved at the same time, it is possible to prevent the supporting base 17 and the cap 51 from interfering with each other in the interference area as long as the speed of at least one of the supporting base 17 and the cap 51 is adjusted.

The maintenance unit is not limited to the cap. The maintenance unit may be one of a receiving portion such as the cap and a flushing box, or a wiper. For example, the maintenance unit may be the wiper. In addition, the cap 51 serves as the flushing box (the receiving portion) and is used for cleaning; however, the maintenance unit may be any one of a cap which only has a function of capping in a standby state, a cap which is only used for cleaning, and a cap (the receiving portion) which is only used as the flushing box. In short, the cap is not limited as long as it has at least one function of a capping function, a flushing box function, and a cleaning function.

The moving mechanism is not limited to the link mechanism as long as it is a mechanism including at least one of a known plurality of mechanisms such as a link mechanism, a crank mechanism, a cam mechanism, and a piston mechanism.

The power sources of the supporting base 17 and the cap 51 are different from each other; however, a common power source may be used. In this case, the activation timing of the supporting base 17 and the cap 51 may be offset via a clutch, or the speed of at least the cap 51 in the supporting base 17 and the cap 51 may be changed via a transmission mechanism. With this configuration, if the speed limit control of the cap 51 is performed, it is possible to prevent the ink from spilling out from the cap 51, and to rapidly replace the positions of the supporting base 17 and the cap 51 with each other.

In the above embodiment, the line printer is employed as an example of the liquid discharge apparatus; however, a scanning type printing apparatus which performs printing by causing a nozzle of a discharging head to discharge ink onto a medium while moving a carriage (or a discharging head) may be employed. For example, a serial type printer in which the carriage is movable in the scanning direction, and a lateral type printer in which the carriage is moveable to two directions of a main scanning direction and a sub-scanning direction may be employed. Also in a case where these types of scanning type printing apparatuses, it is possible to replace the positions of the supporting base and the cap with each other, to rapidly complete the maintenance such as the flushing, and thus to shorten the time required for the printing.

The respective functional units such as the head control unit, the liquid measuring unit, the transporting control unit, the first control unit, and the second control unit which are provided in the controller 90 of the printer 11 may be realized by a computer causing the program to execute software, for example, by an electronic circuit such as a field-programmable gate array (FPGA) or an application specific IC (ASIC) which execute hardware, or may be realized by cooperation of software and hardware.

The medium is not limited to the sheet 14, for example, examples thereof include a film or a sheet which is made of resin, a composite film of resin and metal (a laminated film), fabrics, non-woven fabrics, metal foils, a metal film, and a ceramic sheet.

The liquid discharge apparatus is not limited to the ink jet type printing apparatus (the printer). For example, any liquid discharge apparatus may be used from a liquid discharge apparatus which discharges a liquid material including (by dispersing or dissolving) a material such as an electrode material or a color material (a pixel material) used in manufacturing a display, a liquid discharge apparatus which discharges a bio-organic material used for manufacturing biochips, and a liquid discharge apparatus which discharges the liquid corresponding to a sample used as a precision pipette. Further, any liquid discharge apparatus may be used from a liquid discharge apparatus which discharges a lubricant to a precision machine such as a watch or a camera by using a pin point, a liquid discharge apparatus which discharges a transparent resin solution such as an ultraviolet curing resin onto a substrate so as to form a micro hemispherical lens(an optical lens) used for an optical communication element or the like, and a liquid discharge apparatus which discharges an etchant such as an acid, alkali, or the like so as to etch a substrate or the like. Note that, the meaning of “liquid” includes, for example, a nonorganic solvent, an organic solvent, a solution, a liquid resin, a liquid metal (metal melt), and the like.

The entire discovery of Japanese Patent Application No. 2015-024220, filed Feb. 10, 2015 is expressly incorporated by reference herein.

What is claimed is:

1. A liquid discharge apparatus which discharges a liquid to a medium, comprising:
a discharging head that discharges a liquid to the medium;
a supporting unit that is capable of supporting the medium;
a maintenance unit that is capable of performing maintenance on the discharging head;
a moving mechanism that enables the supporting unit and the maintenance unit to move to a predetermined position facing the discharging head when positions of the supporting unit and the maintenance unit are replaced with each other;
a first power source that causes the supporting unit to move;
a second power source that causes the maintenance unit to move; and
a control unit that controls the first power source and the second power source such that the positions of the supporting unit and the maintenance unit are replaced with each other,
wherein when the positions of the supporting unit and the maintenance unit are replaced with each other, the control unit includes a first period during which one or both of the supporting unit and the maintenance unit are moved, and a second period during which any one of the supporting unit and the maintenance unit is moved, and
wherein an interference area, in which the supporting unit and the maintenance unit interfere with each other when one or both of the supporting unit and the maintenance unit are moved, is set to be the second period.

2. The liquid discharge apparatus according to claim 1,
wherein when the positions of the supporting unit and the maintenance unit are replaced with each other, the control unit controls the first and second power sources such that one of the supporting unit and the maintenance unit, which retracts from the predetermined position, firstly passes through the interference area in a retracting direction, and then the other unit which starts to be moved toward the predetermined position passes through the interference area in a direction close to the discharging head before the one unit is completely retracted.

3. The liquid discharge apparatus according to claim 2, further comprising:
a detecting unit that detects the supporting unit and the maintenance unit approaching an activation position on each moving route thereof,
wherein when the positions of the supporting unit and the maintenance unit are replaced with each other, the control unit controls one of the supporting unit and the maintenance unit, which retracts from the predetermined position, to firstly start to be moved, and then when the detecting unit detects that the one unit approaches the activation position, the control unit controls the other unit starts to be moved toward the predetermined position.

4. The liquid discharge apparatus according to claim 3, p1 wherein at least the maintenance unit of the supporting unit and the maintenance unit has a variable average moving speed, and
wherein the control unit changes an activation timing when the maintenance unit is activated from a retractable position later than a time when the supporting unit starts to be moved from the predetermined position, in accordance with the speed of the maintenance unit.

5. The liquid discharge apparatus according to claim 4,
wherein when one of the supporting unit and the maintenance unit, which starts to be moved from the predetermined position in the interference area, the control unit causes the other unit to start to be moved.

6. The liquid discharge apparatus according to claim 5,
wherein the maintenance unit includes a receiving portion which stores the liquid from the discharging head, and maintenance of the discharging head is performed by receiving the liquid discharged from the discharging head.

7. The liquid discharge apparatus according to claim 6,
wherein the moving route of the maintenance unit includes a movement area having a displacement component in a vertical direction, and
wherein the control unit changes the maximum speed when the maintenance unit ascends to the movement area in accordance with the level of the liquid which is stored in the maintenance unit.

8. The liquid discharge apparatus according to claim 7,
wherein the moving route of the maintenance unit includes the movement area having the displacement component in the vertical direction, and
wherein the control unit further reduces the maximum speed of a course in which the maintenance unit is moved in the movement area in a case where the level of the liquid stored in the maintenance unit is a second liquid level which is higher than a first liquid level, as compared with a case where the level of the liquid stored in the maintenance unit is the first liquid level.

9. The liquid discharge apparatus according to claim 8,
wherein the moving route of the maintenance unit includes the movement area having the displacement component in the vertical direction, and
wherein the control unit further reduces the maximum acceleration of the course in which the maintenance unit is moved in the movement area in the case where the level of the liquid stored in the maintenance unit is a second liquid level which is higher than the first liquid level, as compared with the case where the level of the liquid stored in the maintenance unit is the first liquid level.

10. The liquid discharge apparatus according to claim 9,
wherein the control unit further reduces the maximum value of acceleration in the vertical direction in the course in which the maintenance unit is moved in the movement area in a case where the level of the liquid stored in the maintenance unit is the second liquid level, as compared with the case where the level of the liquid stored in the maintenance unit is the first liquid level.

11. The liquid discharge apparatus according to claim 10,
wherein the moving route of the maintenance unit includes the movement area having the displacement component in the vertical direction, and
wherein the control unit reduces the maximum speed when the maintenance unit ascends to the movement area compared to the maximum speed when the maintenance unit descends to the movement area in a case where the level of the liquid stored in the maintenance unit is constant.

12. The liquid discharge apparatus according to claim 11,
wherein the control unit further reduces an average moving speed of the maintenance unit in a case where the level of the liquid in the maintenance unit is the second liquid level which is higher than the first liquid level, as compared with the case where the level of the liquid stored in the maintenance unit is the first liquid level.

13. The liquid discharge apparatus according to claim 12,
wherein the control unit counts the number of times of liquid discharge which is performed by the discharging head with respect to the maintenance unit, and the liquid level is obtained from the number of times of the liquid discharge.

14. A control method of a liquid discharge apparatus in which positions of a supporting unit that is capable of supporting a medium which is a discharging target of a liquid from a discharging head and a maintenance unit that is capable of performing maintenance on the discharging head are replaced with each other with respect to a predetermined position facing the discharging head, the method comprising:
replacing dispositional positions of the supporting unit and the maintenance unit with each other in a state where the supporting unit is disposed in a predetermined position when a maintenance implementation time is reached;
performing maintenance of the discharging head by the maintenance unit; and
replacing dispositional positions of the supporting unit and the maintenance unit with each other after completing the maintenance,
wherein in the replacings, a first period during which one or both of the supporting unit and the maintenance unit are moved, and a second period during which any one of the supporting unit and the maintenance unit is moved are provided when the positions of the supporting unit and the maintenance unit are replaced with each other, and
wherein an interference area, in which the supporting unit and the maintenance unit interfere with each other when one or both of the supporting unit and the maintenance unit are moved, is set to be the second period.
